(19) United States
(12) Patent Application Publication
(10) Pub. No.: US 2023/0069947 A1
(43) Pub. Date: Mar. 9, 2023

(54) METHOD FOR TRANSMITTING AND RECEIVING SIGNAL IN WIRELESS COMMUNICATION SYSTEM, AND APPARATUS SUPPORTING SAME

(71) Applicant: LG ELECTRONICS INC., Seoul (KR)

(72) Inventors: Jeongsu LEE, Seoul (KR); Hyunsu CHA, Seoul (KR)

(73) Assignee: LG ELECTRONICS INC., Seoul (KR)

(21) Appl. No.: 17/759,784

(22) PCT Filed: Mar. 2, 2021
(86) PCT No.: PCT/KR2021/002529

§ 371 Date: Jul. 29, 2022

(30) Foreign Application Priority Data
Feb. 27, 2020 (KR) 10-2020-0024604

(51) Int. Cl. H04W 68/02; H04W 72/12; H04L 1/00; H04W 24/10; H04W 4/90

(52) U.S. Cl. CPC H04W 68/02; H04W 72/1289; H04L 1/0061; H04W 24/10; H04W 4/90

(57) ABSTRACT

Various embodiments relate to a next generation wireless communication system for supporting a data transmission rate and the like higher than that of the 4^{th} generation (4G) wireless communication system. According to various embodiments, a method for transmitting and receiving a signal in a wireless communication system, and an apparatus for supporting same may be provided, and other various embodiments may also be provided.

### TECHNICAL FIELD

Various embodiments are related to a wireless communication system.

### BACKGROUND ART

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

### DISCLOSURE

### Technical Problem

Various embodiments may provide a method and apparatus for transmitting and receiving a signal in a wireless communication system.

Various embodiments may provide a method for triggering a positioning measurement operation for a terminal in a wireless communication system and an apparatus supporting the same.

It will be appreciated by persons skilled in the art that the objects that could be achieved with the various embodiments are not limited to what has been particularly described hereinabove and the above and other objects that the various embodiments could achieve will be more clearly understood from the following detailed description.

### Technical Solution

Various embodiments may provide a method for transmitting and receiving a signal in a wireless communication system and an apparatus supporting the same.

According to various embodiments, a method carried out by an apparatus in a wireless communication system may be provided.

According to various embodiments, the method may include receiving configuration information related to paging, and receiving, based on the configuration information, downlink control information (DCI) having a cyclic redundancy check (CRC) scrambled with a radio network temporary identifier (RNTI) related to the paging.

According to various embodiments, the DCI may include a first bit field.

According to various embodiments, the first bit field having a first value may be mapped to the apparatus being configured to acquire a measurement related to positioning.

According to various embodiments, the first bit field having a second value may be mapped to scheduling information for the paging being included in the DCI.

According to various embodiments, the first bit field having a third value may be mapped to a short message being included in the DCI.

According to various embodiments, the first bit field having a fourth value may be mapped to the scheduling information and the short message being included in the DCI.

According to various embodiments, the short message may include (i) information about system information modification, and (ii) an indication related to one or more of an earthquake and tsunami warning system (ETWS) or a commercial mobile alert system (CMAS).

According to various embodiments, the short message may further include a second bit field.

According to various embodiments, a most significant bit (MSB) of the second bit field may include information about the system information modification,

According to various embodiments, a second MSB of the second bit field may include information about an indication related to one or more of the ETWS or the CMAS,

According to various embodiments, remaining bits of the second bit field except for the MSB and the second MSB include a bitmap for configuring a positioning method for acquiring the measurement.

According to various embodiments, based on the first bit field having the first value, (i) the measurement may be acquired, and (ii) a paging message related to the paging may not be expected to be received.

According to various embodiments, the terminal may be included in a group including one or more terminals.

According to various embodiments, the first bit field having the first value may be mapped to the one or more terminals included in the group being configured to acquire the measurement in a group-common manner.

According to various embodiments, based on the first bit field having the first value, a positioning reference signal (PRS) used to acquire the measurement may not be received after a reception time of the DCI.

According to various embodiments, a terminal operating in a wireless communication system may be provided.

According to various embodiments, the terminal may include a transceiver, and one or more processors connected to the transceiver.

According to various embodiments, the one or more processors may be configured to receive configuration information related to paging, and receive, based on the configuration information, downlink control information (DCI) having a cyclic redundancy check (CRC) scrambled with a radio network temporary identifier (RNTI) related to the paging.

According to various embodiments, the DCI may include a first bit field.

According to various embodiments, the first bit field having a first value may be mapped to an apparatus being configured to acquire a measurement related to positioning.

According to various embodiments, the first bit field having a second value may be mapped to scheduling information for the paging being included in the DCI.

According to various embodiments, the first bit field having a third value may be mapped to a short message being included in the DCI.

According to various embodiments, the first bit field having a fourth value may be mapped to the scheduling information and the short message being included in the DCI.

According to various embodiments, the short message may include (i) information about system information modification, and (ii) an indication related to one or more of an earthquake and tsunami warning system (ETWS) or a commercial mobile alert system (CMAS).

According to various embodiments, the short message may further include a second bit field.

According to various embodiments, a most significant bit (MSB) of the second bit field may include information about the system information modification.

According to various embodiments, a second MSB of the second bit field may include information about an indication related to one or more of the ETWS or the CMAS,

According to various embodiments, remaining bits of the second bit field except for the MSB and the second MSB may include a bitmap for configuring a positioning method for acquiring the measurement.

According to various embodiments, the terminal may be included in a group including one or more terminals.

According to various embodiments, the first bit field having the first value may be mapped to the one or more terminals included in the group being configured to acquire the measurement in a group-common manner.

According to various embodiments, the one or more processors may be configured to communicate with one or more of a mobile terminal, a network, and an autonomous vehicle other than a vehicle containing the apparatus.

According to various embodiments, a method carried out by an apparatus in a wireless communication system may be provided.

According to various embodiments, the method may include transmitting configuration information related to paging, and transmitting downlink control information (DCI) having a cyclic redundancy check (CRC) scrambled with a radio network temporary identifier (RNTI) related to the paging.

According to various embodiments, the DCI transmitted to a terminal may include a first bit field.

According to various embodiments, the first bit field having a first value may be mapped to the terminal being configured to acquire a measurement related to positioning.

According to various embodiments, the first bit field having a second value may be mapped to scheduling information for the paging being included in the DCI.

According to various embodiments, a base station operating in a wireless communication system may be provided.

According to various embodiments, the base station may include a transceiver, and one or more processors connected to the transceiver.

According to various embodiments, the one or more processors may be configured to transmit configuration information related to paging, and transmit downlink control information (DCI) having a cyclic redundancy check (CRC) scrambled with a radio network temporary identifier (RNTI) related to the paging.

According to various embodiments, the DCI transmitted to a terminal may include a first bit field.

According to various embodiments, the first bit field having a first value may be mapped to the terminal being configured to acquire a measurement related to positioning, and

According to various embodiments, the first bit field having a second value may be mapped to scheduling information for the paging being included in the DCI.

According to various embodiments, an apparatus operating in a wireless communication system may be provided.

According to various embodiments, the apparatus may include one or more processors, and one or more memories storing one or more instructions to cause the one or more processors to carry out a method.

According to various embodiments, the method may include receiving configuration information related to paging, and receiving, based on the configuration information, downlink control information (DCI) having a cyclic redundancy check (CRC) scrambled with a radio network temporary identifier (RNTI) related to the paging.

According to various embodiments, the DCI may include a first bit field.

According to various embodiments, the first bit field having a first value may be mapped to the apparatus being configured to acquire a measurement related to positioning.

According to various embodiments, the first bit field having a second value may be mapped to scheduling information for the paging being included in the DCI.

According to various embodiments, a processor-readable medium storing one or more instructions to cause one or more processors to carry out a method may be provided.

According to various embodiments, the method may include receiving configuration information related to paging, and receiving, based on the configuration information, downlink control information (DCI) having a cyclic redundancy check (CRC) scrambled with a radio network temporary identifier (RNTI) related to the paging.

According to various embodiments, the DCI may include a first bit field.

According to various embodiments, the first bit field having a first value may be mapped to the apparatus being configured to acquire a measurement related to positioning.

According to various embodiments, the first bit field having a second value may be mapped to scheduling information for the paging being included in the DCI.

Various embodiments as described above are only some of preferred embodiments of the various embodiments, and those skilled in the art may derive and understand many embodiments in which technical features of the various embodiments are reflected based on the following detailed description.

### Advantageous Effects

According to various embodiments, a signal may be effectively transmitted and received in a wireless communication system.

According to various embodiments, positioning may be effectively performed in a wireless communication system.

According to various embodiments, a triggering method for a positioning measurement operation for an RRC-connected terminal as well as an RRC idle/inactive terminal may be provided.

According to various embodiments, a positioning measurement operation for an RRC connected terminal as well as an RRC idle/inactive terminal may be provided without ambiguity.

According to various embodiments, signaling overhead may be reduced.

It will be appreciated by persons skilled in the art that the effects that can be achieved with the various embodiments are not limited to what has been particularly described hereinabove and other advantages of the various embodiments will be more clearly understood from the following detailed description taken in conjunction with the accompanying drawings.

### DESCRIPTION OF DRAWINGS

The accompanying drawings are provided to help understanding of various embodiments, along with a detailed description. However, the technical features of various embodiments are not limited to a specific drawing, and features disclosed in each drawing may be combined with each other to constitute a new embodiment. Reference numerals in each drawing denote structural elements.

FIG. 1 is a diagram illustrating physical channels and a signal transmission method using the physical channels, which may be used in various embodiments.

FIG. 2 is a diagram illustrating a resource grid in a new radio (NR) system to which various embodiments are applicable.

FIG. 3 is a diagram illustrating mapping of physical channels in a slot, to which various embodiments are applicable.

FIG. 4 is a diagram illustrating radio resource control (RRC) states, RRC state transition, and a mobility procedure supported between an NR/next generation core (NGC) and an evolved-universal terrestrial radio access network/evolved packet core (E-UTRAN/EPC), to which various embodiments are applicable.

FIG. 5 is a diagram illustrating an example of paging to which various embodiments are applicable.

FIG. 6 is a diagram illustrating an exemplary discontinuous reception (DRX) operation according to various embodiments.

FIG. 7 is a diagram illustrating a positioning protocol configuration for positioning a user equipment (UE), to which various embodiments are applicable.

FIG. 8 is a diagram illustrating protocol layers for supporting LTE positioning protocol (LPP) message transmission, to which various embodiments are applicable.

FIG. 9 is a diagram illustrating protocol layers for supporting NR positioning protocol a (NRPPa) protocol data unit (PDU) transmission, to which various embodiments are applicable.

FIG. 10 is a diagram illustrating an observed time difference of arrival (OTDOA) positioning method, to which various embodiments are applicable.

FIG. 11 is a diagram illustrating a multi-round trip time (multi-RTT) positioning method to which various embodiments are applicable.

FIG. 12 is a diagram schematically illustrating a method of operating a UE, a transmission and reception point (TRP), a location server, and/or a location management function (LMF) according to various embodiments.

FIG. 13 is a diagram schematically illustrating a method of operating a UE, a TRP, a location server, and/or an LMF according to various embodiments.

FIG. 14 is a diagram schematically illustrating a method of operating a UE and network nodes according to various embodiments.

FIG. 15 is a flowchart illustrating a method of operating a UE according to various embodiments.

FIG. 16 is a flowchart illustrating a method of operating a network node according to various embodiments.

FIG. 17 is a diagram illustrating a device for implementing various embodiments.

FIG. 18 is a diagram illustrating a communication system applied to various embodiments.

FIG. 19 is a diagram illustrating an example of wireless devices applied to various embodiments.

FIG. 20 is a diagram illustrating another example of wireless devices applied to various embodiments.

FIG. 21 is a diagram illustrating a portable device applied to various embodiments.

FIG. 22 is a diagram illustrating a vehicle or an autonomous driving vehicle applied to various embodiments.

### MODE FOR DISCLOSURE

Various embodiments are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

Various embodiments are described in the context of a 3GPP communication system (e.g., including LTE, NR, 6G, and next-generation wireless communication systems) for clarity of description, to which the technical spirit of the various embodiments is not limited. For the background art, terms, and abbreviations used in the description of the various embodiments, refer to the technical specifications published before the present disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

1. 3GPP System

1.1. Physical Channels and Signal Transmission and Reception

In a wireless access system, a UE receives information from a base station on a downlink (DL) and transmits information to the base station on an uplink (UL). The information transmitted and received between the UE and the base station includes general data information and various types of control information. There are many physical channels according to the types/usages of information transmitted and received between the base station and the UE.

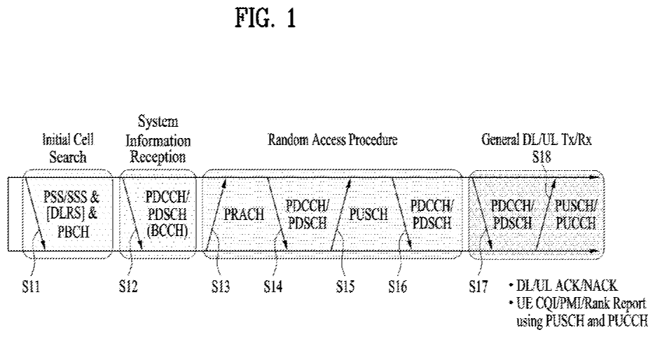

FIG. 1 is a diagram illustrating physical channels and a signal transmission method using the physical channels, which may be used in various embodiments.

When powered on or when a UE initially enters a cell, the UE performs initial cell search involving synchronization with a BS in step S11. For initial cell search, the UE receives a synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S12.

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a physical uplink shared channel (PUSCH) by using scheduling information in the RAR (S15), and perform a contention resolution procedure including reception of a PDCCH signal and a PDSCH signal corresponding to the PDCCH signal (S16).

Aside from the above 4-step random access procedure (4-step RACH procedure or type-1 random access procedure), when the random access procedure is performed in two steps (2-step RACH procedure or type-2 random access procedure), steps S13 and S15 may be performed as one UE transmission operation (e.g., an operation of transmitting message A (MsgA) including a PRACH preamble and/or a PUSCH), and steps S14 and S16 may be performed as one BS transmission operation (e.g., an operation of transmitting message B (MsgB) including an RAR and/or contention resolution information)

After the above procedure, the UE may receive a PDCCH and/or a PDSCH from the BS (S17) and transmit a PUSCH and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

1.2. Physical Resources

Regarding physical resources in the NR system, antenna ports, a resource grid, resource elements (REs), resource blocks (RBs), carrier parts, and so one may be considered. The physical resources in the NR system will be described below in detail.

An antenna port is defined such that a channel conveying a symbol on an antenna port may be inferred from a channel conveying another symbol on the same antenna port. When the large-scale properties of a channel carrying a symbol on one antenna port may be inferred from a channel carrying a symbol on another antenna port, the two antenna ports may be said to be in a quasi co-located or quasi co-location (QCL) relationship. The large-scale properties include one or more of delay spread, Doppler spread, frequency shift, average received power, received timing, average delay, and a spatial reception (Rx) parameter. The spatial Rx parameter refers to a spatial (Rx) channel property parameter such as an angle of arrival.

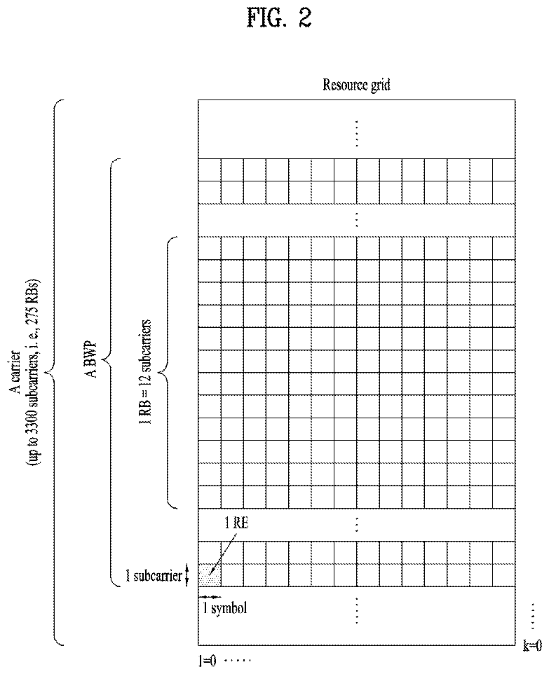

FIG. 2 illustrates an exemplary resource grid to which various embodiments are applicable.

Referring to FIG. 2, for each subcarrier spacing (SCS) and carrier, a resource grid is defined as 14×2^{μ} OFDM symbols by N_{grid}^{Size,μ}×N_{SC}^{RB} subcarriers, where N_{grid}^{Size,μ} is indicated by RRC signaling from the BS. N_{grid}^{Size,μ} may vary according to an SCS configuration μ and a transmission direction, UL or DL. There is one resource grid for an SCS configuration μ, an antenna port p, and a transmission direction (UL or DL). Each element of the resource grid for the SCS configuration μ and the antenna port p is referred to as an RE and uniquely identified by an index pair (k, l) where k represents an index in the frequency domain, and l represents a symbol position in the frequency domain relative to a reference point. The RE (k, l) for the SCS configuration μ and the antenna port p corresponds to a physical resource and a complex value α_{k,l}^{(p,μ)}. An RB is defined as N_{SC}^{RB}=12 consecutive subcarriers in the frequency domain.

Considering that the UE may not be capable of supporting a wide bandwidth supported in the NR system, the UE may be configured to operate in a part (bandwidth part (BWP)) of the frequency bandwidth of a cell.

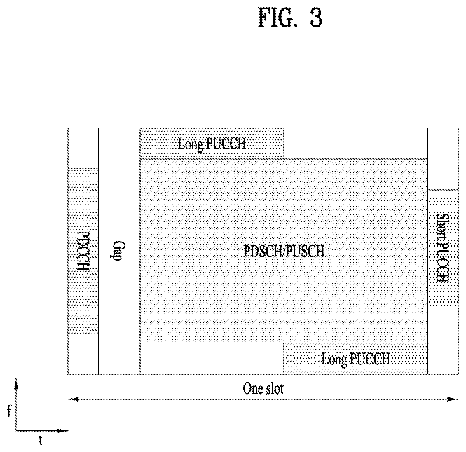

FIG. 3 is a diagram illustrating exemplary mapping of physical channels in a slot, to which various embodiments are applicable.

One slot may include all of a DL control channel, DL or UL data, and a UL control channel. For example, the first N symbols of a slot may be used to transmit a DL control channel (hereinafter, referred to as a DL control region), and the last M symbols of the slot may be used to transmit a UL control channel (hereinafter, referred to as a UL control region). Each of N and M is an integer equal to or larger than 0. A resource area (hereinafter, referred to as a data region) between the DL control region and the UL control region may be used to transmit DL data or UL data. There may be a time gap for DL-to-UL or UL-to-DL switching between a control region and a data region. A PDCCH may be transmitted in the DL control region, and a PDSCH may be transmitted in the DL data region. Some symbols at a DL-to-UL switching time in the slot may be used as the time gap.

The BS transmits related signals to the UE on DL channels as described below, and the UE receives the related signals from the BS on the DL channels.

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping are performed on a codeword basis, and modulation symbols generated from each codeword are mapped to one or more layers (layer mapping). Each layer together with a demodulation reference signal (DMRS) is mapped to resources, generated as an OFDM symbol signal, and transmitted through a corresponding antenna port.

The PDCCH may deliver downlink control information (DCI), for example, DL data scheduling information, UL data scheduling information, and so on. The PUCCH may deliver uplink control information (UCI), for example, an acknowledgement/negative acknowledgement (ACK/NACK) information for DL data, channel state information (CSI), a scheduling request (SR), and so on.

The PDCCH carries downlink control information (DCI) and is modulated in quadrature phase shift keying (QPSK). One PDCCH includes 1, 2, 4, 8, or 16 control channel elements (CCEs) according to an aggregation level (AL). One CCE includes 6 resource element groups (REGs). One REG is defined by one OFDM symbol by one (P)RB.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The UE acquires DCI delivered on a PDCCH by decoding (so-called blind decoding) a set of PDCCH candidates. A set of PDCCH candidates decoded by a UE are defined as a PDCCH search space set. A search space set may be a common search space (CSS) or a UE-specific search space (USS). The UE may acquire DCI by monitoring PDCCH candidates in one or more search space sets configured by an MIB or higher-layer signaling.

The UE transmits related signals on later-described UL channels to the BS, and the BS receives the related signals on the UL channels from the UE.

The PUSCH delivers UL data (e.g., a UL-shared channel transport block (UL-SCH TB)) and/or UCI, in cyclic prefix-orthogonal frequency division multiplexing (CP-OFDM) waveforms or discrete Fourier transform-spread-orthogonal division multiplexing (DFT-s-OFDM) waveforms. If the PUSCH is transmitted in DFT-s-OFDM waveforms, the UE transmits the PUSCH by applying transform precoding. For example, if transform precoding is impossible (e.g., transform precoding is disabled), the UE may transmit the PUSCH in CP-OFDM waveforms, and if transform precoding is possible (e.g., transform precoding is enabled), the UE may transmit the PUSCH in CP-OFDM waveforms or DFT-s-OFDM waveforms. The PUSCH transmission may be scheduled dynamically by a UL grant in DCI or semi-statically by higher-layer signaling (e.g., RRC signaling) (and/or layer 1 (L1) signaling (e.g., a PDCCH)) (a configured grant). The PUSCH transmission may be performed in a codebook-based or non-codebook-based manner.

The PUCCH delivers UCI, an HARQ-ACK, and/or an SR and is classified as a short PUCCH or a long PUCCH according to the transmission duration of the PUCCH.

1.3. Radio Resource Control (RRC) States

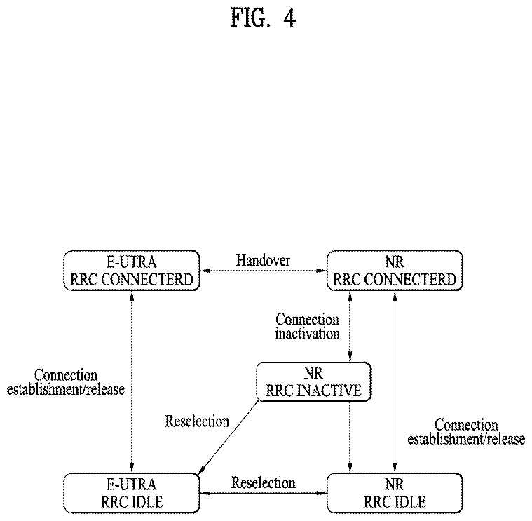

FIG. 4 is a diagram illustrating RRC states, RRC state transition, and a mobility procedure supported between an NR/next generation core (NGC) and an evolved-universal terrestrial radio access network/evolved packet core (E-UTRAN/EPC), to which various embodiments are applicable.

The UE has only one RRC state at a specific time. The RRC state indicates whether the RRC layer of the UE is logically connected to the layer of the NG radio access network (RAN). When an RRC connection has been established, the UE may be in an RRC_CONNECTED state or an RRC_INACTIVE state. When the RRC connection has not been established, the UE is in an RRC_IDLE state.

In the RRC_CONNECTED state or the RRC_INACTIVE state, the UE has an RRC connection, and accordingly, the NG RAN may recognize the existence of the UE on a cell basis. On the other hand, in the RRC_IDLE state, the UE may not be recognized by the NG RAN and is managed by a core network on a tracking area basis. A tracking area is a unit wider than a cell.

When a user initially turns on the UE, the UE searches for an appropriate cell and maintains the RRC_IDLE state in the cell. Only when the RRC_IDLE-state UE needs to establish an RRC connection, the RRC_IDLE-state UE establishes the RRC connection with the NG RAN in an RRC connection procedure, and transitions to the RRC_CONNECTED state or the RRC_INACTIVE state.

The RRC states of the UE have the following features.

(1) RRC_IDLE State
The UE may be configured with discontinuous reception (DRX) by a higher layer.
The mobility of the UE is controlled based on a network configuration.
The UE monitors a paging channel.
The UE performs neighbor cell measurement and cell (re)selection.
The UE acquires system information.

(2) RRC_INACTIVE State
The UE may be configured with DRX by the higher layer or RRC layer.
The mobility of the UE is controlled based on a network configuration.
The UE stores an access stratum (AS) context.
The UE monitors a paging channel.
The UE performs neighbor cell measurement and cell (re)selection.
When the UE moves outside a RAN-based notification area, the UE performs RAN-based notification area update.
The UE acquires system information.

(3) RRC_CONNECTED State
The UE stores an AS context.
The UE transmits and receives unicast data.
At a lower layer, the UE may be configured with UE-specific DRX.
A UE supporting carrier aggregation (CA) may use one or more secondary cells (SCells) aggregated with a special cell (SpCell), for an increased bandwidth.
A UE supporting dual connectivity (DC) may use a secondary cell group (SCG) aggregated with a master cell group (MCG), for an increased bandwidth.
The UE monitors a paging channel.
When data is scheduled for the UE, the UE monitors a control channel associated with a shared data channel.
The UE provides channel quality and feedback information.
The UE performs neighbor cell measurement and cell (re)selection.
The UE acquires system information.

Particularly, the RRC_IDLE or RRC_INACTIVE UE may operate as described in Table 1 below.

TABLE 1

| | UE procedure |
|---|---|
| 1^{st} step | a public land mobile network (PLMN) selection when a UE is |
| | switched on |
| 2^{nd} Step | cell (re)selection for searching a suitable cell |
| 3^{rd} Step | tune to its control channel (camping on the cell) |
| 4^{th} Step | Location registration and a RAN-based Notification Area |
| | (RNA) update |

1.4. Paging

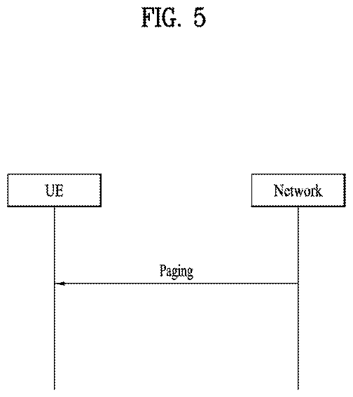

FIG. 5 is a diagram illustrating an example of paging to which various embodiments are applicable.

The paging and/or paging procedure may be used to transmit paging information to an RRC_IDLE or RRC_INACTIVE UE in a network. Additionally/alternatively, the paging and/or paging procedure may be used to transmit a system information (SI) change and/or an earthquake and tsunami warning system (ETWS)/commercial mobile alert system (CMAS) notification to UEs in an RRC_IDLE, RRC_INACTIVE, or RRC_CONNECTED state.

The network may initiate the paging procedure by transmitting a paging message on a paging occasion of the UE. The network may address one or more UEs by including one paging record (e.g., PagingRecord) for each UE in the paging message. The paging message may contain a paging record list (e.g., PagingRecordList), which is a sequence of paging records.

Each paging record may include information on a UE identifier (e.g., UE-Identity) and an access type (e.g., accessType). The UE identifier may be selected from a temporary mobile subscriber identity (TMSI) (e.g., ng-5G-S-TMSI)/I-RNTI (inactive RNTI) (e.g., full-RNTI). The access type may indicate whether a paging message is generated from a non-3GPP access due to a PDU session.

Upon receiving the paging message, the UE may operate as follows.

For each PagingRecord contained in the paging message (if included), when UE-Identity included in PagingRecord the UE identify allocated from the upper layer, the UE in RRC_IDLE state may forward UE-Identity and accessType (if included) to the upper layer.

For each PagingRecord contained in the paging message (if included), the UE in the RRC_INACTIVE state may operate as follows:
When the UE-Identity included in the PagingRecord matches the full-RNTI stored in the UE, the UE may perform/initiate an RRC connection resumption procedure.
When the UE-Identity included in the PagingRecord matches the UE identity allocated from the upper layer, the UE may perform an operation related to switching to the RRC_IDLE state and/or enter the RRC_IDLE state.

1.5. DRX (Discontinuous Reception)

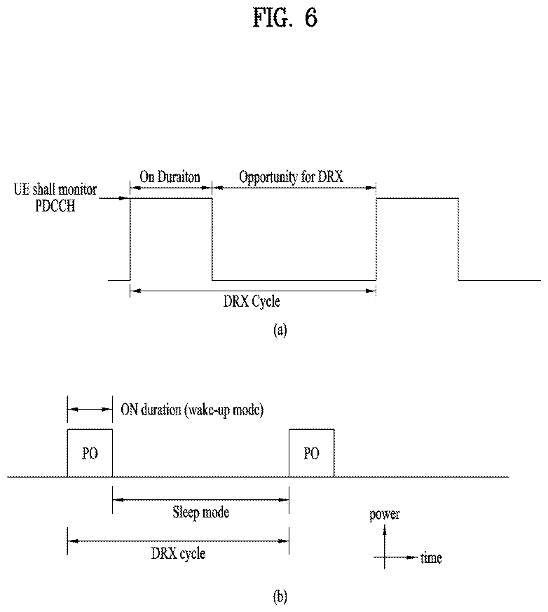

FIG. 6 is an exemplary DRX operation according to various embodiments.

According to various embodiments, the UE may perform a DRX operation in the afore-described/proposed procedures and/or methods. When the UE is configured with DRX, the UE may reduce power consumption by receiving a DL signal discontinuously. DRX may be performed in an RRC_IDLE state, an RRC_INACTIVE state, and an RRC_CONNECTED state. In the RRC_IDLE state and the RRC_INACTIVE state, DRX is used to receive a paging signal discontinuously.

RRC_CONNECTED DRX

In in the RRC_CONNECTED state, DRX is used to receive a PDCCH discontinuously. DRX in the RRC_CONNECTED state is referred to as RRC_CONNECTED DRX).

Referring to FIG. 6(a), a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, the UE may perform PDCCH monitoring/reception discontinuously in the time domain in the afore-described procedures and/or methods. For example, when DRX is configured, PDCCH reception occasions (e.g., slots with PDCCH search spaces) may be configured discontinuously according to a DRX configuration in the present disclosure. On the contrary, when DRX is not configured, the UE may perform PDCCH monitoring/reception continuously in the time domain in the afore-described procedures and/or methods according to implementation(s). For example, when DRX is not configured, PDCCH reception occasions (e.g., slots with PDCCH search spaces) may be configured continuously in the present disclosure. Irrespective of whether DRX is configured, PDCCH monitoring may be restricted during a time period configured as a measurement gap.

Table 2 describes a DRX operation of a UE (in the RRC_CONNECTED state). Referring to Table 2, DRX configuration information is received by higher-layer signaling (e.g., RRC signaling), and DRX ON/OFF is controlled by a DRX command from the MAC layer. Once DRX is configured, the UE may perform PDCCH monitoring discontinuously the afore-described procedures and/or methods according to various embodiments.

TABLE 2

| | Type of signals | UE procedure |
|---|---|---|
| 1^{st} step | RRC signalling | Receive DRX |
| | (MAC- | configuration |
| | CellGroupConfig) | information |
| 2^{nd} Step | MAC CE | Receive DRX |
| | ((Long) DRX command | command |
| | MAC CE) | |
| 3^{rd} Step | — | Monitor a PDCCH |
| | | during an on-duration |
| | | of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected.
Value of drx-HARQ-RTT-TimerDL: defines the duration of a maximum time period until a DL retransmission is received after reception of a DL initial transmission.
Value of drx-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.

drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

RRC_IDLE DRX

In the RRC_IDLE state and the RRC_INACTIVE state, DRX is used to receive a paging signal discontinuously. For convenience, DRX performed in the RRC_IDLE (or RRC_INACTIVE) state is referred to as RRC_IDLE DRX.

Therefore, when DRX is configured, PDCCH monitoring/reception may be performed discontinuously in the time domain in the afore-described/proposed procedures and/or methods.

Referring to FIG. 6(b), DRX may be configured for discontinuous reception of a paging signal. The UE may receive DRX configuration information from the BS by higher-layer (e.g., RRC) signaling. The DRX configuration information may include a DRX cycle, a DRX offset, configuration information for a DRX timer, and the like. The UE repeats an On Duration and a Sleep duration according to a DRX cycle. The UE may operate in a wakeup mode during the On duration and in a sleep mode during the Sleep duration. In the wakeup mode, the UE may monitor a paging occasion (PO) to receive a paging message. A PO means a time resource/interval (e.g., subframe or slot) in which the UE expects to receive a paging message. PO monitoring includes monitoring a PDCCH (MPDCCH or NPDCCH) scrambled with a P-RNTI (hereinafter, referred to as a paging PDCCH) in a PO. The paging message may be included in the paging PDCCH or in a PDSCH scheduled by the paging PDCCH. One or more POs may be included in a paging frame (PF), and the PF may be periodically configured based on a UE ID. A PF may correspond to one radio frame, and the UE ID may be determined based on the International Mobile Subscriber Identity (IMSI) of the UE. When DRX is configured, the UE monitors only one PO per DRX cycle. When the UE receives a paging message indicating a change of its ID and/or system information in a PO, the UE may perform an RACH procedure to initialize (or reconfigure) a connection with the BS, or receive (or obtain) new system information from the BS. Therefore, PO monitoring may be performed discontinuously in the time domain to perform an RACH procedure for connection to the BS or to receive (or obtain) new system information from the BS in the afore-described procedures and/or methods.

2. Positioning

Positioning may refer to determining the geographical position and/or velocity of the UE based on measurement of radio signals. Location information may be requested by and reported to a client (e.g., an application) associated with to the UE. The location information may also be requested by a client within or connected to a core network. The location information may be reported in standard formats such as formats for cell-based or geographical coordinates, together with estimated errors of the position and velocity of the UE and/or a positioning method used for positioning.

2.1. Positioning Protocol Configuration

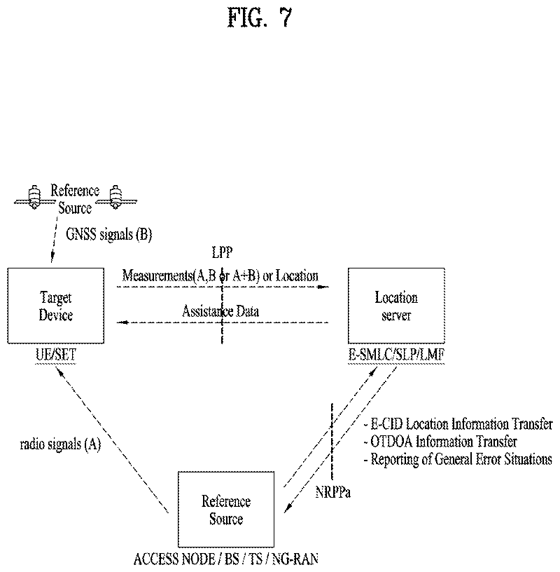

FIG. 7 is a diagram illustrating an exemplary positioning protocol configuration for positioning a UE, to which various embodiments are applicable.

Referring to FIG. 7, an LTE positioning protocol (LPP) may be used as a point-to-point protocol between a location server (E-SMLC and/or SLP and/or LMF) and a target device (UE and/or SET), for positioning the target device using position-related measurements acquired from one or more reference resources. The target device and the location server may exchange measurements and/or location information based on signal A and/or signal B over the LPP.

NRPPa may be used for information exchange between a reference source (access node and/or BS and/or TP and/or NG-RAN node) and the location server.

The NRPPa protocol may provide the following functions.
E-CID Location Information Transfer. This function allows the reference source to exchange location information with the LMF for the purpose of E-CID positioning.
OTDOA Information Transfer. This function allows the reference source to exchange information with the LMF for the purpose of OTDOA positioning.
Reporting of General Error Situations. This function allows reporting of general error situations, for which function-specific error messages have not been defined.

2.2. Positioning Reference Signal (PRS)

For such positioning, a positioning reference signal (PRS) may be used. The PRS is a reference signal used to estimate the position of the UE.

A positioning frequency layer may include one or more PRS resource sets, each including one or more PRS resources.

Sequence Generation

A PRS sequence r(m) (m=0, 1, . . . ) may be defined by Equation 1.

$$r ( m ) = \frac{1}{\sqrt{2}} ( 1 - 2 c ( m ) ) + j \frac{1}{\sqrt{2}} ( 1 - 2 c ( m + 1 ) ) \qquad [ Equation 1 ]$$

In Equation 1, c(i) may be a pseudo-random sequence. A pseudo-random sequence generator may be initialized by Equation 2.

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} \qquad [ Equation 2 ]$$

In Equation 2, n_{s,f}^{μ} may be a slot number in a frame in an SCS configuration μ. A DL PRS sequence ID n_{ID,seq}^{PRS} ∈{0, 1, . . . , 4095} may be given by a higher-layer parameter (e.g., DL-PRS-SequenceId). 1 may be an OFDM symbol in a slot to which the sequence is mapped.

Mapping to Physical Resources in DL a PRS Resource

A PRS sequence r(m) may be scaled by β_{PRS} and mapped to REs (k, l)_{p,μ}, specifically by Equation 3. (k, l)_{p,μ} may represent an RE (k, l) for an antenna port p and the SCS configuration μ.

α_{k,l}^{(p,μ)}=β_{PRS}r(m) [Equation 3]

m=0, 1, . . .

k=mK_{comb}^{PRS}+((k_{offset}^{PRS}+k′)mod K_{comb}^{PRS})

l=lₛₜₐᵣₜ^{PRS},lₛₜₐᵣₜ^{PRS}+1, . . . ,lₛₜₐᵣₜ^{PRS}+L_{PRS}−1

Herein, the following conditions may have to be satisfied:
The REs (k, l)_{p,μ} are included in an RB occupied by a DL PRS resource configured for the UE;
The symbol 1 not used by any SS/PBCH block used by a serving cell for a DL PRS transmitted from the serving cell or indicated by a higher-layer parameter SSB-positionInBurst for a DL PRS transmitted from a non-serving cell;
A slot number satisfies the following PRS resource set-related condition;
lₛₜₐᵣₜ^{PRS} is the first symbol of the DL PRS in the slot, which may be given by a higher-layer parameter DL-PRS-ResourceSymbolOffset. The time-domain size of the DL PRS resource, L_{PRS}∈{2, 4, 5, 12} may be given by a higher-layer parameter DL-PRS-NumSymbols. A comb size K_{comp}^{PRS}∈{2, 4, 6, 12} may be given by a higher-layer parameter transmissionComb. A combination {L_{PRS},K_{comb}^{PRS}} of L_{PRS} and K_{comb}^{PRS} may be one of {2, 2}, {4, 2}, {6, 2}, {12, 2}, {4, 4}, {12, 4}, {6, 6}, {12, 6} and/or {12, 12}. An RE offset k_{offset}^{PRS}∈{0, 1, . . . , K_{comb}^{PRS}−1} may be given by combOffset. A frequency offset k′ may be a function of l−lₛₜₐᵣₜ^{PRS} as shown in Table 6.

TABLE 6

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

A reference point for k=0 may be the position of point A in a positioning frequency layer in which the DL PRS resource is configured. Point A may be given by a higher-layer parameter dl-PRS-PointA-r16.

Mapping to Slots in a DL PRS Resource Set

A DL PRS resource included in a DL PRS resource set may be transmitted in a slot and a frame which satisfy the following Equation 4.

(Nₛₗₒₜ^{frame,μ}n_{f}+n_{s,f}^{μ}−T_{offset}^{PRS}−T_{offset,res}^{PRS})mod 2^{μ}Tₚₑᵣ^{PRS}∈{iT_{gap}^{PRS}}ᵢ₌₀^{T}^{ᵣₑₚ}^{^{PRS}}⁻¹ [Equation 4]

Nₛₗₒₜ^{frame,μ} may be the number of slots per frame in the SCS configuration μ. n_{f} may be a system frame number (SFN). n_{s,f}^{μ} may be a slot number in a frame in the SCS configuration μ. A slot offset T_{offset}^{PRS}∈{0, 1, . . . , Tₚₑᵣ^{PRS}−1} may be given by a higher-layer parameter DL-PRS-ResourceSetSlotOffset. A DL PRS resource slot offset T_{offset,res}^{PRS} may be given by a higher layer parameter DL-PRS-ResourceSlotOffset. A periodicity Tₚₑᵣ^{PRS}∈{4, 5, 8, 10, 16, 20, 32, 40, 64, 80, 160, 320, 640, 1280, 2560, 5120, 10240} may be given by a higher-layer parameter DL-PRS-Periodicity. A repetition factor Tᵣₑₚ^{PRS}∈{1, 2, 4, 6, 8, 16, 32} may be given by a higher-layer parameter DL-PRS-ResourceRepetitionFactor. A muting repetition factor T_{muting}^{PRS} may be given by a higher-layer parameter DL-PRS-MutingBitRepetitionFactor. A time gap T_{gap}^{PRS}∈{1, 2, 4, 8, 16, 32} may be given by a higher-layer parameter DL-PRS-ResourceTimeGap.

2.3. Protocol for Positioning Measurement

LTE Positioning Protocol (LPP)

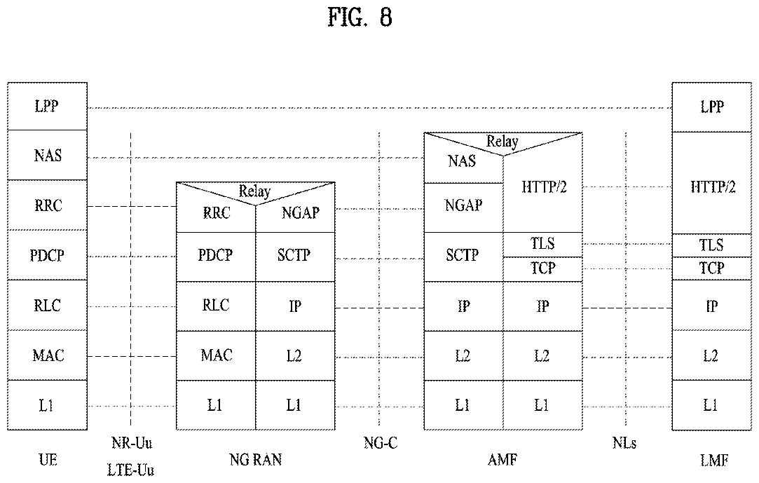

FIG. 8 is a diagram illustrating exemplary protocol layers for supporting LPP message transmission, to which various embodiments are applicable. An LPP PDU may be transmitted in a NAS PDU between an AMF and a UE.

Referring to FIG. 8, LPP is terminated between a target device (e.g., a UE in a control plane or an SUPL enabled terminal (SET) in a user plane) and a location server (e.g., an LMF in the control plane or an SLP in the user plane). LPP messages may be carried as transparent PDUs cross intermediate network interfaces using appropriate protocols, such an NGAP over an NG-C interface and NAS/RRC over LTE-Uu and NR-Uu interfaces. LPP is intended to enable positioning for NR and LTE using various positioning methods.

For example, a target device and a location server may exchange, through LPP, capability information therebetween, assistance data for positioning, and/or location information. The target device and the location server may exchange error information and/or indicate abort of an LPP procedure, through an LPP message.

NR Positioning Protocol A (NRPPa)

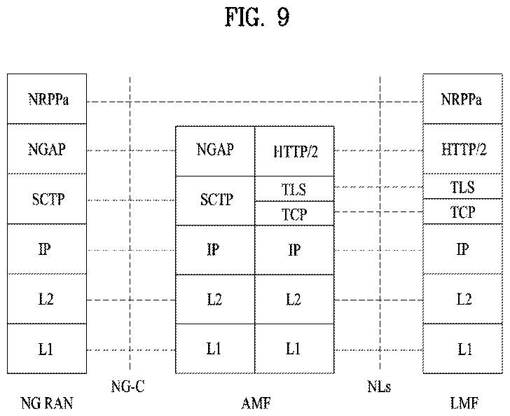

FIG. 9 is a diagram illustrating exemplary protocol layers for supporting NRPPa PDU transmission, to which various embodiments are applicable.

NRPPa may be used to carry information between an NG-RAN node and an LMF. Specifically, NRPPa may carry an E-CID for measurement transferred from an ng-eNB to an LMF, data for support of an OTDOA positioning method, and a cell-ID and a cell position ID for support of an NR cell ID positioning method. An AMF may route NRPPa PDUs based on a routing ID of an involved LMF over an NG-C interface without information about related NRPPa transaction.

An NRPPa procedure for location and data collection may be divided into two types. The first type is a UE associated procedure for transfer of information about a particular UE (e.g., location measurement information) and the second type is a non-UE-associated procedure for transfer of information applicable to an NG-RAN node and associated TPs (e.g., gNB/ng-eNB/TP timing information). The two types may be supported independently or may be supported simultaneously.

2.4. Positioning Measurement Method

Positioning methods supported in the NG-RAN may include a Global Navigation Satellite System (GNSS), an OTDOA, an enhanced cell ID (E-CID), barometric sensor positioning, WLAN positioning, Bluetooth positioning, a terrestrial beacon system (TBS), uplink time difference of arrival (UTDOA) etc. Although any one of the positioning methods may be used for UE positioning, two or more positioning methods may be used for UE positioning.

OTDOA (Observed Time Difference of Arrival)

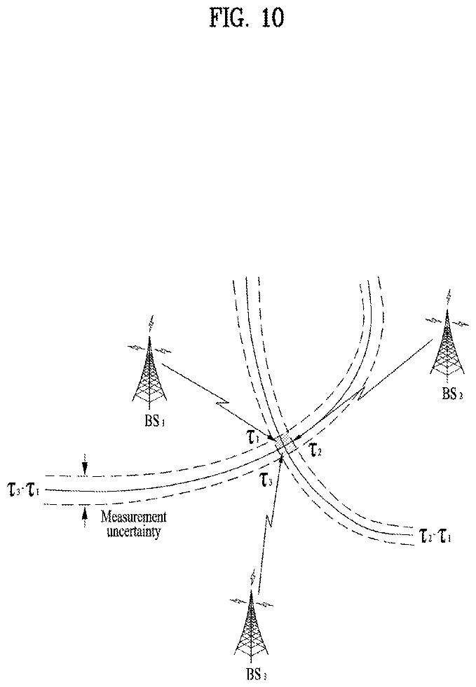

FIG. 10 is a view illustrating an OTDOA positioning method, which may be used in various embodiments.

The OTDOA positioning method uses time measured for DL signals received from multiple TPs including an eNB, an ng-eNB, and a PRS-only TP by the UE. The UE measures time of received DL signals using location assistance data received from a location server. The position of the UE may be determined based on such a measurement result and geographical coordinates of neighboring TPs.

The UE connected to the gNB may request measurement gaps to perform OTDOA measurement from a TP. If the UE is not aware of an SFN of at least one TP in OTDOA assistance data, the UE may use autonomous gaps to obtain an SFN of an OTDOA reference cell prior to requesting measurement gaps for performing reference signal time difference (RSTD) measurement.

Here, the RSTD may be defined as the smallest relative time difference between two subframe boundaries received from a reference cell and a measurement cell. That is, the RSTD may be calculated as the relative time difference between the start time of a subframe received from the measurement cell and the start time of a subframe from the reference cell that is closest to the subframe received from the measurement cell. The reference cell may be selected by the UE.

For accurate OTDOA measurement, it is necessary to measure time of arrival (ToA) of signals received from geographically distributed three or more TPs or BSs. For example, ToA for each of TP 1, TP 2, and TP 3 may be measured, and RSTD for TP 1 and TP 2, RSTD for TP 2 and TP 3, and RSTD for TP 3 and TP 1 are calculated based on three ToA values. A geometric hyperbola is determined based on the calculated RSTD values and a point at which curves of the hyperbola cross may be estimated as the position of the UE. In this case, accuracy and/or uncertainty for each ToA measurement may occur and the estimated position of the UE may be known as a specific range according to measurement uncertainty.

For example, RSTD for two TPs may be calculated based on Equation 5 below.

$${RSTDi}_{, 1} = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 5 ]$$

where c is the speed of light, {xt, yt} are (unknown) coordinates of a target UE, {xi, yi} are (known) coordinates of a TP, and {x1, y1} are coordinates of a reference TP (or another TP). Here, (Ti-T1) is a transmission time offset between two TPs, referred to as “real time differences” (RTDs), and ni and n1 are UE ToA measurement error values.

E-CID (Enhanced Cell ID)

In a cell ID (CID) positioning method, the position of the UE may be measured based on geographical information of a serving ng-eNB, a serving gNB, and/or a serving cell of the UE. For example, the geographical information of the serving ng-eNB, the serving gNB, and/or the serving cell may be acquired by paging, registration, etc.

The E-CID positioning method may use additional UE measurement and/or NG-RAN radio resources in order to improve UE location estimation in addition to the CID positioning method. Although the E-CID positioning method partially may utilize the same measurement methods as a measurement control system on an RRC protocol, additional measurement only for UE location measurement is not generally performed. In other words, an additional measurement configuration or measurement control message may not be provided for UE location measurement. The UE does not expect that an additional measurement operation only for location measurement will be requested and the UE may report a measurement value obtained by generally measurable methods.

For example, the serving gNB may implement the E-CID positioning method using an E-UTRA measurement value provided by the UE.

Measurement elements usable for E-CID positioning may be, for example, as follows.
UE measurement: E-UTRA reference signal received power (RSRP), E-UTRA reference signal received quality (RSRQ), UE E-UTRA reception (RX)-transmission (TX) time difference, GERAN/WLAN reference signal strength indication (RSSI), UTRAN common pilot channel (CPICH) received signal code power (RSCP), and/or UTRAN CPICH Ec/Io
E-UTRAN measurement: ng-eNB RX-TX time difference, timing advance (TADV), and/or AoA

Here, TADV may be divided into Type 1 and Type 2 as follows.

TADV Type 1=(ng-eNB RX-TX time difference)+(UE E-UTRA RX-TX time difference)

TADV Type 2=ng-eNB RX-TX time difference

AoA may be used to measure the direction of the UE. AoA is defined as the estimated angle of the UE counterclockwise from the eNB/TP. In this case, a geographical reference direction may be north. The eNB/TP may use a UL signal such as an SRS and/or a DMRS for AoA measurement. The accuracy of measurement of AoA increases as the arrangement of an antenna array increases. When antenna arrays are arranged at the same interval, signals received at adjacent antenna elements may have constant phase rotate.

Multi RTT (Multi-Cell RTT)

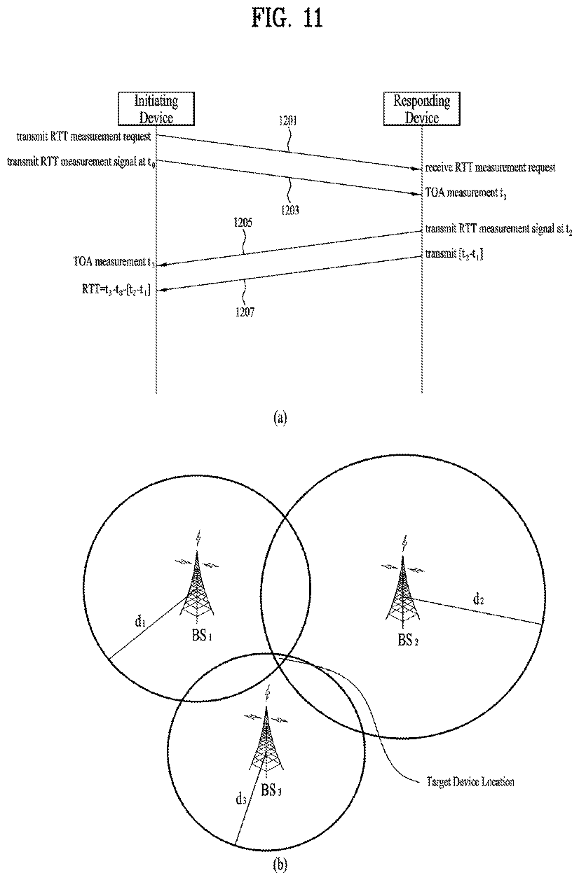

FIG. 11 is a diagram illustrating an exemplary multi-round trip time (multi-RTT) positioning method to which various embodiments are applicable.

Referring to FIG. 11(a), an exemplary RTT procedure is illustrated, in which an initiating device and a responding device perform ToA measurements, and the responding device provides ToA measurements to the initiating device, for RTT measurement (calculation). The initiating device may be a TRP and/or a UE, and the responding device may be a UE and/or a TRP.

In operation 1301 according to various embodiments, the initiating device may transmit an RTT measurement request, and the responding device may receive the RTT measurement request.

In operation 1303 according to various embodiments, the initiating device may transmit an RTT measurement signal at t0 and the responding device may acquire a ToA measurement t1.

In operation 1305 according to various embodiments, the responding device may transmit an RTT measurement signal at t2 and the initiating device may acquire a ToA measurement t3.

In operation 1307 according to various embodiments, the responding device may transmit information about [t2-t1], and the initiating device may receive the information and calculate an RTT by Equation 6. The information may be transmitted and received based on a separate signal or in the RTT measurement signal of operation 1305.

RTT=t₃−t₀−[t₂−t₁] [Equation 6]

Referring to FIG. 11(b), the RTT may correspond to a double-range measurement between the two devices. Positioning estimation may be performed from the information. Based on the measured RTT, d1, d2 and d3 may be determined, and a target device location may be determined to be the intersection of circles with BS1, BS2, and BS3 (or TRPs) at the centers and radiuses of d1, d2 and d3.

### 3. Various Embodiments

A detailed description will be given of various embodiments based on the above technical ideas. The afore-described contents of Section 1 and Section 2 are applicable to various embodiments described below. For example, operations, functions, terminologies, and so on which are not defined in various embodiments may be performed and described based on Section 1 and Section 2.

Symbols/abbreviations/terms used in the description of various embodiments may be defined as follows.
A/B/C: A and/or B and/or C
CMAS: commercial mobile alert system. For example, a CMAS may be a public warning system developed to provide multiple simultaneous alert notifications.
ECID: enhanced cell identifier
ETWS: earthquake and tsunami warning system. For example, the ETWS may be a public warning system developed to meet regulatory requirements for warning notifications related to earthquakes and/or tsunamis. For example, an ETWS alert notification may include a primary notification (brief notification) and/or an ETWS secondary notification (detailed notification).
GNSS: global navigation satellite system
LMF: location management function
OTDOA: observed time difference of arrival
PRS: positioning reference signal
RTT: round trip time
RSTD: reference signal time difference/relative signal time difference
SIB: system information block
SSB: synchronization signal block. It may be understood as the same as a synchronization signal/physical broadcast channel (SS/PBCH) block.
TRP: transmission and reception point (TP: transmission point)

In description of various embodiments, the BS may be understood as a comprehensive term including a remote radio head (RRH), an eNodeB (eNB), a gNodeB (gNodeB), a TP, a reception point (RP), and a relay.

In description of various embodiments, “exceeding/greater than or equal to A” may be replaced with “greater than or equal to/exceeding A.”

Unless specifically mentioned otherwise, the PDCCH may be a paging PDCCH in description of various embodiments.

Unless specifically stated otherwise, in description of various embodiments, the DCI may be a paging DCI and may be included in the paging PDCCH.

Unless specifically stated otherwise, in description of various embodiments, PDSCH may mean a PDSCH scheduled from the paging PDCCH/paging DCI.

In description of various embodiments, a UE-based positioning method may be related to a method by which a UE directly calculates/acquires location/position information thereon.

In description of various embodiments, the UE-assisted positioning method may be related to a method by which the UE calculates/acquires and reports measurements related to UE location/positioning (e.g., values used by the BS/server/LMF for UE positioning; e.g., measured values for one or more of RSTD, AoA, AoD, RTT, and ToA), and the network node (e.g., BS/server/LMF, etc.) that receives this report calculates/acquires location/positioning information on the UE.

For example, in the UE-assisted positioning method, the result of measurement by the UE should be transmitted/reported to the BS or the like, and therefore a separate resource for such transmission/reporting may be allocated.

For example, in the UE-based positioning method, the UE directly calculates/acquires the location thereof based on the measurement result from the UE, and accordingly it may not be necessary to allocate a separate resource for transmission/reporting. As another example, in the UE-based positioning method, when the UE needs to transmit/report the location information thereon to the BS/server/LMF (e.g., when the UE is configured to transmit/report the information to the BS/server/LMF), a separate resource for transmission/reporting may be allocated.

For example, one or more of the following details may be considered in order to support DL positioning measurements in the idle/inactive modes:

1) In both UE-assisted and UE-based methods:
Regardless of the positioning methods (e.g., UE-assisted and UE-based methods), the UE may perform positioning measurement based on information transmitted through RRC information/system information;
For example, connection may be established only in the minimum SIB, and the minimum SIB may not include the positioning SIB (posSIB);
For example, when dedicated PRS configuration is allowed, resources may be used more efficiently and/or the location may be more accurately estimated.

2) In the UE-assisted method, the UE may fail to transmit the measurement report when resources for the measurement report are not configured/allocated.

According to various embodiments, in consideration of the above-described matters, dedicated signaling without switching to the RRC connected state may be considered.

According to various embodiments, some procedures (e.g., a paging-related procedure, a RACH-related procedure, etc.) before switching to the RRC connected state may be used. For example, a paging message, and/or message 2, and/or message 3, and/or message A may be used. For example, a 2-step random access procedure and/or a 4-step random access procedure may be used. For example, since the RRC idle/inactive UE may perform PRS or SSB measurement, the UE may calculate/acquire timing measurement. For example, a timing measurement may be reported from message A PUSCH in the two-step random access procedure. For example, the BS may transmit gNB Rx-Tx time difference measurement to the UE through message B of the two-step random access procedure, and the UE may calculate/acquire the RTT based on the measurement. Additionally, triggering the PRS measurement and/or measurement report of the UE from paging may be considered.

Various embodiments may relate to triggering conditions for positioning measurement on a UE. In the following description of various embodiments, various embodiments are described, taking a positioning method based on PRS measurement as an example. However, various embodiments are not limited thereto.

For example, various measurement methods may be applied to triggering for positioning measurement based on a reference signal (e.g., SSB/CSI-RS (channel state information reference signal, etc.) other than the PRS and/or a method (e.g., a positioning method based on GNSS/barometric pressure sensor/WLAN/Bluetooth/TBS/motion sensor, etc.) other than the method using a reference signal.

In a wireless communication system (e.g., a wireless communication system supporting Release 16 and/or earlier standard technology) to which various embodiments are applicable, UE positioning may be supported for an RRC connected UE. However, support for positioning of RRC idle/active UEs is considered due to, for example, the need for more accurate management of the location/positioning information about the RRC idle/active UE by the BS/server (location server)/LMF and/or the need for direct management of the location/positioning information by the RRC idle/active UE. For example, by supporting the positioning of the RRC idle/inactive UE, a gain may be obtained in terms of time and/or power required for state transition of the UE.

For example, in the case of an RRC idle/inactive UE, the direct connection between the UE and the BS/server/LMF is limited (for example, there is no LPP connection), and accordingly a positioning mechanism using a predetermined/defined/configured rule/mechanism may be needed. For example, it may be necessary to discuss how to transmit request information on positioning measurement/measurement report (MR)/location information/positioning information to the UE.

Various embodiments may relate to a method for positioning an RRC idle/inactive UE using paging. For example, the embodiments may relate to a UE-based and/or UE-assisted positioning method using paging. In the following description of various embodiments, various embodiments will be described, focusing on a UE-based positioning method based on paging as an example. However, various embodiments are not limited thereto. For example, various embodiments may also be applied to the UE-assisted positioning method.

According to various embodiments, the BS/server/LMF may transmit paging for purposes such as RRC connection setup, system information modification/change, and PWS/ETWS notification, and may (additionally) transmit paging for UE-based and/or UE-assisted positioning measurement for the UE. According to various embodiments, utilization and/or operation related to paging of a UE and/or a BS/server/LMF may be proposed.

Various embodiments may relate to requesting location information using paging when a BS/location server/LMF or the like desires to receive a measurement report from a UE.

For example, when the BS/server/LMF desires to receive a measurement report from the UE, the BS/server/LMF may send a request for location information and/or transmit/deliver request location information to the UE. For example, the request for location information and/or transmission and reception of the request location information may be based on paging.

For example, the request for location information and/or the request location information may functionally perform two functions: 1) requesting PRS measurement from the UE (e.g., the BS/server/LMF starts PRS transmission) and 2) transmitting requested contents information in a report from the UE after measurement. For example, the functions of the request for location information and/or request location information may be replaced with paging.

In description of various embodiments, the contents information may refer to information to be reported by the UE in relation to measurement for positioning. For example, the contents information may be one or more of information on PRS resource ID used in acquiring RSTD, RTT, or a measured value, information on PRS resource set ID used in acquiring the measured value, information on TP used in acquiring the measured value, information on a time stamp, or information on the quality of the measured value, but is not limited thereto.

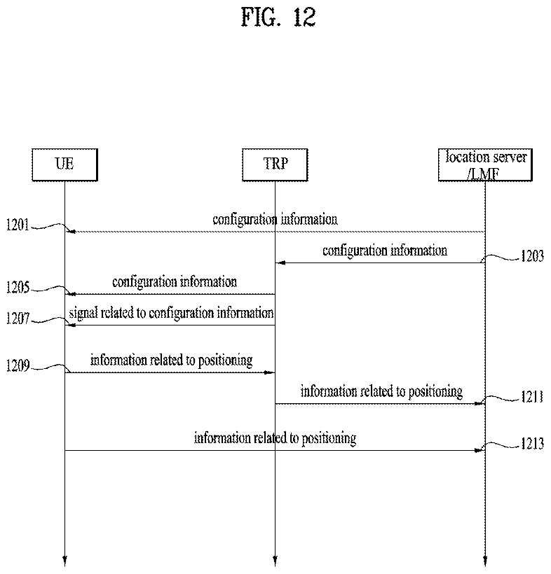

FIG. 12 is a diagram schematically illustrating a method of operating a UE, a TRP, a location server, and/or an LMF according to various embodiments.

Referring to FIG. 12, in operation 1201 according to various embodiments, the location server and/or the LMF may transmit configuration information to the UE, and the UE may receive the same.

In operation 1203 according to various embodiments, the location server and/or LMF may transmit reference configuration information to the TRP, and the TRP may receive the same. In operation 1205 according to various embodiments, the TRP may transmit the reference configuration information to the UE, and the UE may receive the same. In this case, operation 1201 according to various embodiments may be omitted.

Alternatively, operations 1203 and 1205 according to various embodiments may be omitted. In this case, operation 1201 according to various embodiments may be performed.

That is, operation 1201 according to various embodiments and operations 1203 and 1205 according to various embodiments may be optional.

In operation 1207 according to various embodiments, the TRP may transmit a signal related to the configuration information to the UE, and the UE may receive the signal. For example, the signal related to the configuration information may be a signal for positioning of the UE.

In operation 1209 according to various embodiments, the UE may transmit a signal related to positioning to the TRP, and the TRP may receive the same. In operation 2011 according to various embodiments, the TRP may transmit a signal related to positioning to the location server and/or the LMF, and the location server and/or the LMF may receive the same.

In operation 1213 according to various embodiments, the UE may transmit the signal related to positioning to the location server and/or the LMF, and the location server and/or the LMF may receive the same. In this case, operations 1209 and 1211 according to various embodiments may be omitted.

Alternatively, operation 1213 according to various embodiments may be omitted. In this case, operations 1211 and 1213 according to various embodiments may be performed.

That is, operations 1209 and 1211 according to various embodiments and operation 1213 according to various embodiments may be optional.

According to various embodiments, the signal related to the positioning may be acquired based on the configuration information and/or the signal related to the configuration information.

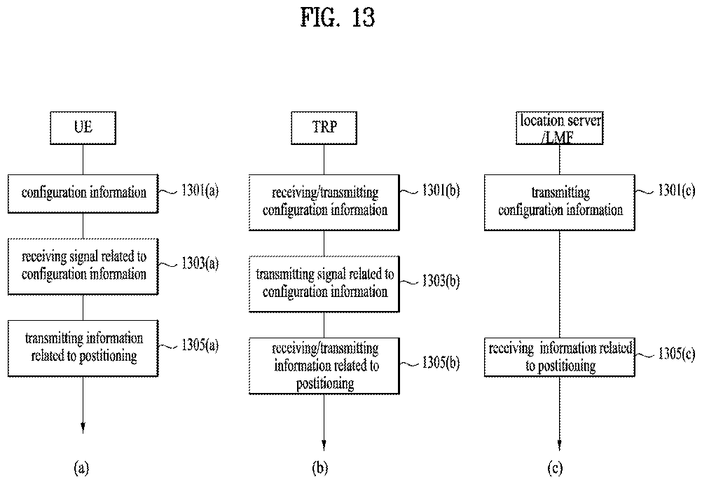

FIG. 13 is a diagram schematically illustrating a method of operating a UE, a TRP, a location server, and/or an LMF according to various embodiments.

Referring to FIG. 13-(a), in operation 1301(a) according to various embodiments, the UE may receive configuration information.

In operation 1303(a) according to various embodiments, the UE may receive a signal related to the configuration information.

In operation 1305(a) according to various embodiments, the UE may transmit information related to positioning.

Referring to FIG. 13-(b), in operation 1301(b) according to various embodiments, the TRP may receive configuration information from the location server and/or the LMF, and may transmit the same to the UE.

In operation 1303(b) according to various embodiments, the TRP may transmit a signal related to the configuration information.

In operation 1305(b) according to various embodiments, the TRP may receive information related to positioning, and may transmit the same to the location server and/or LMF.

Referring to FIG. 13-(c), in operation 1301(c) according to various embodiments, the location server and/or the LMF may transmit configuration information.

In operation 1305(c) according to various embodiments, the location server and/or LMF may receive information related to positioning.

For example, the configuration information may be understood as being related to reference configuration (information), one or more pieces of information that the location server, and/or the LMF, and/or the TRP transmits/configures to the UE, or the like, or may be understood as the reference configuration (information), one or more pieces of information that the location server, and/or the LMF, and/or the TRP transmits/configures to the UE, or the like in the description of various embodiments given below.

For example, the signal related to positioning described above may be understood as a signal related to one or more pieces of information reported by the UE in the description of various embodiments below and/or a signal including one or more pieces of information reported by the UE.

For example, in the description of various embodiments below, a BS, a gNB, a cell, or the like may be replaced with a TRP, a TP, or any device that performs the same function.

For example, in the description of various embodiments given below, the location server may be replaced with an LMF or any device that performs the same function.

More specific operations, functions, terms, and the like in operations according to various embodiments may be performed and described based on various embodiments to be described below. Operations according to each of the various embodiments are exemplary, and one or more of the above-described operations may be omitted according to the details of each embodiment.

Hereinafter, various embodiments will be described in detail. Various embodiments to be described below may be combined in all or in part to form other various embodiments as long as they are not mutually excluded, which may be clearly understood by those skilled in the art.

Various embodiments may relate to use of paging for positioning measurement for a UE in an RRC idle/inactive state (e.g., UE-based positioning measurement).

For example, the network may initiate paging while delivering paging PDCCH on a configured/specified/defined paging opportunity (PO). For example, the purpose of paging may be RRC connection setup, system information modification/change, PWS/ETWS notification, or the like.

Various embodiments may relate to a method of (additionally) transmitting paging for positioning measurement in addition to the above purpose and/or, in this case, a detailed operation of the UE/BS/server/LMF.

According to various embodiments, the positioning measurement procedure may include requesting and/or transmitting information on capability between a BS/server/LMF and a target (e.g., a UE), transmitting assistance data, and/or transmitting and receiving information on location information. For example, the request for location information and/or request location information transmitted from the BS/server/LMF may functionally perform functions of 1) requesting PRS measurement from the UE (e.g., the BS/server/LMF starts PRS transmission) and 2) transmitting requested contents information in a report from the UE after measurement. For simplicity, in description of various embodiments below, 1) the function of requesting PRS measurement from the UE may be referred to as function 1, and 2) the function of transmitting requested contents information in a report from the UE after measurement may be referred to as function 2. According to various embodiments, the functions of a request for location information and/or the request location information may be replaced with paging.

According to various embodiments, depending on where and/or how information related to function 1 and/or function 2 is transmitted and received, the UE and/or the BS/server/LMF may operate based on one or more of the embodiments described below.

Method 1: Using PDCCH

In a wireless communication system (e.g., an NR system) to which various embodiments are applicable, a paging message may contain/include only paging record information, unlike in the LTE system. For example, information on system information modification/change and/or information on an indication related to the earthquake and tsunami warning system (ETWS)/commercial mobile alert system (CMAS) may be specified/defined/configured as a short message and transmitted to the UE on the PDCCH (DCI).

According to various embodiments, DCI for paging and/or related to paging may be used in a positioning measurement method. For example, the DCI may include information related to the short message.

Hereinafter, DCI format 1_0 is described as an example of the DCI. However, this is merely a specific example of various embodiments, and the format of the DCI is not limited thereto. For example, DCI format 1_0 in the following description of various embodiments may be replaced with DCI and/or a signal for paging and/or related to paging. For example, it may be distinguished by an identifier related to the DCI and/or signal. For example, the DCI may have a cyclic redundancy check (CRC) scrambled with a radio network temperature identifier (RNTI) related to paging. For example, the RNTI related to paging may be a paging-RNTI (P-RNTI).

For example, in a wireless communication system (e.g., an NR system) to which various embodiments are applicable, one or more pieces of the following information may be transmitted through DCI format 1_0 having a CRC scrambled with the P-RNTI.

Short message indicator: 2 bits

Short message: 8 bits. When only scheduling information for paging is carried, the corresponding bit field may be reserved.
Frequency domain resource assignment: ┌log₂(N_{RB}^{DL,BWP}(N_{RB}^{DL,BWP}+1)/2┐. When only a short message is carried, the corresponding bit field may be reserved. N_{R}^{BDL,BWP} may be the size of control resource set (CORESET) 0 (CORESET through which PDCCH for scheduling SIB1) is transmitted.
Time domain resource assignment: 4 bits. When only the short message is carried, the corresponding bit field may be reserved.
Virtual resource block (VRB)-to-physical resource block (PRB) mapping: 1 bit. When only the short message is carried, the corresponding bit field may be reserved.
Modulation and coding scheme (MCS): 5 bits. When only the short message is carried, the corresponding bit field may be reserved.
Transport block (TB) scaling: 2 bits. When only the short message is carried, the corresponding bit field may be reserved.
Reserved bit: 8 bits for operation in a cell with a shared spectrum; otherwise, 6 bits.

For example, the short message may be transmitted with or without an associated paging message on a PDCCH using P-RNTI. For example, it may be transmitted in a short message field included in DCI format 1_0.

For example, the short message may be defined as shown in Table 4. In Table 4, bit 1 may represent the most significant bit (MSB), and the subsequent bits may be sequential bits after the MSB.

TABLE 4

| Bit | Short Message |
|---|---|
| 1 | systemInfoModification |
| | If set to 1: indication of a BCCH modification |
| | other than SIB6, SIB7 and SIB8. |
| 2 | etwsAndCmasIndication |
| | If set to 1: indication of an ETWS primary notification and/or an |
| | ETWS secondary notification and/or a CMAS notification. |
| 3-8 | Not used and shall be ignored by UE if received. |

For example, bit 1 may correspond/be mapped to systemInfoModification. For example, when bit 1 is set to 1 (or 0), a broadcast control channel (BCCH) change/SIB change may be indicated except for SIB6, SIB7, and SIB8.

For example, bit 2 may correspond/be mapped to etwsAndCmasIndication. For example, when bit 2 is set to 1 (or 0), ETWS primary notification, and/or ETWS secondary notification, and/or CMAS notification may be indicated.

For example, bits 3 to 8 may be reserved and/or unused. For example, when bits 3 to 8 are received, they may be ignored by the UE.

Alt. 1: reserved state in short message indicator

According to various embodiments, positioning measurement may be configured/indicated based on DCI for paging and/or related to paging. For example, the DCI may include a bit field related to configuring/indicating positioning measurement. For example, the bit field related to configuring/indicating positioning measurement may be a bit field related to a short message. For example, the bit field may be related to a short message indicator. For example, when the bit field has a predetermined value, it may indicate that the UE is configured to perform positioning measurement and/or may correspond to/be mapped the configuration.

According to various embodiments, the reserved state of the short message may be used to configure/indicate UE-specific/group (e.g., a UE-group including one or more/multiple UEs)-based positioning measurement (e.g., UE-based positioning measurement). Unless otherwise stated, in description of various embodiments, a (single) UE may be replaced with multiple UEs (included in the UE-group), and the multiple UEs (included in the UE-group) may be replaced with a (single) UE.

For example, in a wireless communication system (e.g., an NR system) to which various embodiments are applicable, the short message indicator (in 2 bits) may be defined as shown in Table 5.

TABLE 5

| Bit field | Short Message indicator |
|---|---|
| 00 | Reserved |
| 01 | Only scheduling information for Paging is |
| | present in the DCI |
| 10 | Only short message is present in the DCI |
| 11 | Both scheduling information for Paging and |
| | short message are present in the DCI |

For example, when the value of the bit field is “00,” it may correspond/be mapped to the reserved one/state. For example, when the value of the bit field is “01,” it may correspond/be mapped to only scheduling information for paging being present in the DCI. For example, when the value of the bit field is “10,” it may correspond/be mapped to only the short message being present in the DCI. For example, when the value of the bit field is “11,” it may correspond/be mapped to both scheduling information for paging and a short message being present in the DCI.

According to various embodiments, the BS/server/LMF configure/indicate positioning measurement (e.g., UE-based positioning measurement) for a UE/a plurality of UEs (included in the UE-group) receiving DCI/paging (including the corresponding bit field) using uses a reserved state ‘00’ (a reserved state corresponding/mapped to the value of the bit field being “00”). For example, the configured/indicated positioning measurement may be related to a request for location information and/or request location information. For example, it may be related to function 1 of the request for location information and/or the request location information.

According to various embodiments, the short message indicator (in 2 bits) may be defined/modified as shown in Table 6 and/or understood as shown in Table 6.

TABLE 6

| Bit field | Short Message indicator |
|---|---|
| 00 | Positioning measurement |
| 01 | Only scheduling information for Paging is |
| | present in the DCI |
| 10 | Only short message is present in the DCI |
| 11 | Both scheduling information for Paging and |
| | short message are present in the DCI |

Referring to Table 6, according to various embodiments, when the short message indicator, which is a bit field in the DCI, is “00,” the UE may perform positioning measurement. For example, when the short message indicator is “00,” the UE may perform PRS measurement. For example, when the short message indicator is “00,” the UE may not expect to decode the paging message, and/or may not expect the paging message, and/or may not receive the paging message, and/or may not decode the paging message. For example, the UE may perform PRS measurement without expecting to decode the paging message.

According to various embodiments, the UE of the group for which positioning is configured/indicated may acquire/calculate a required positioning result using a default measurement method/scheme transmitted through system information, and/or may acquire/calculate a required positioning result using one or more of measurement methods (supported by the UE) other than the default measurement method.

Specifically, according to various embodiments, the default measurement method/scheme to be carried out by the UE may be transmitted from the system information. For example, when the bit field in the DCI is “00,” the UE (and/or a plurality of UEs included in the UE-group) may acquire/calculate a required positioning result by performing the default measurement method/scheme transmitted from the system information. For example, one or more of the positioning methods/schemes based on OTDOA/ECID/Multi-RTT/GNSS/barometric pressure sensor/WLAN/Bluetooth/TBS/motion sensor may be configured/indicated as the default measurement method/scheme. As another example, the default measurement method/scheme to be carried out by the UE may be predefined instead of being configured by signaling such as separate configuration information. For example, one or more of the positioning methods/schemes based on the OTDOA/ECID/Multi-RTT/GNSS/barometric pressure sensor/WLAN/BluetoothTBS/motion sensor may be predefined as the default measurement method/scheme.

Additionally/alternatively, according to various embodiments, the UE may acquire/calculate a required positioning result using a measurement method different from the measurement method configured/indicated as the default measurement method, and/or may use one or more of the measurement methods (supported by the UE) to acquire/calculate the required positioning result even when the default measurement method/scheme is not configured/indicated. For example, the measurement method carried out by the UE may correspond to a positioning result required by the UE. For example, when the positioning result required by the UE corresponds to the RSTD, OTDOA may be performed. Additionally/alternatively, when the positioning result required by the UE corresponds to the RTT, Multi-RTT may be performed. Additionally/alternatively, when the result corresponds to a measurement according to a barometric pressure sensor required by the UE, a measurement method based on the barometric pressure sensor may be carried out.

In the above description, various embodiments have been described about an example case where the size of the bit field for indicating positioning measurement is 2 bits as an example. However, various embodiments are not limited thereto. According to various embodiments, the size of the bit field for indicating positioning measurement may have various values as well as 2 bits.

For example, the size of the bit field for indicating positioning measurement may be 1 bit. In this case, when the bit field for indicating the positioning measurement has a first value, it may correspond/be mapped to the positioning measurement being configured/indicated for the UE. When the bit field for indicating the positioning measurement has a second value, it may correspond/be mapped to one or more of scheduling information for paging being included in the DCI and/or the scheduling information and the short message being included in the DCI.

In the above description, various embodiments have been described about an example case where positioning measurement is configured/indicated when the value of the bit field for indicating the positioning measurement is ‘00’. However, various embodiments are not limited thereto.

For example, when the bit field for indicating positioning measurement has a first value, it may correspond/be mapped to the positioning measurement being configured/indicated for the UE. When the bit field for indicating the positioning measurement has a second value, it may correspond/be mapped to scheduling information for paging being included in the DCI. When the bit field for indicating the positioning measurement has a third value, it may correspond/be mapped to a short message being included in the DCI. When the bit field for indicating the positioning measurement has a fourth value, it may correspond/be mapped to the scheduling information and the short message being included in the DCI. For example, when the size of the bit field for indicating the positioning measurement exceeds 2 bits, the bit field for indicating the positioning measurement having a value other than the first to fourth values may correspond/be mapped to reserved, and/or be used to transmit another indication/configuration to the UE.

Alt. 2: Location Information Accompanied in Short Message

According to various embodiments, a positioning method and/or a positioning measurement method may be indicated based on DCI for paging and/or related to paging. For example, the DCI may include a bit field related to configuring/indicating a positioning method and/or a positioning measurement method. For example, the bit field related to configuring/indicating a positioning method and/or a positioning measurement method may be a bit field related to a short message. For example, the bit field may be a short message and/or may include the short message. For example, at least a portion of the bit field may configure/indicate the positioning method and/or the positioning measurement method with a bitmap.

For example, as described above regarding Alt. 1 according to various embodiments, the UE may calculate/acquire a required result value (measurement information) by carrying out a measurement method configured by default and/or corresponding to the measurement result required by the UE. As another example, the reserved bit of the short message may be used for the BS/server/LMF to directly configure/indicate the positioning method (e.g., OTDOA/ECID/Multi-RTT/GNSS/barometric pressure sensor/WLAN/Bluetooth/TBS/motion sensor, etc.).

According to various embodiments, the short message may be additionally used for configuration/indication of a positioning method as well as system information modification and/or notification of CMAS/ETWS.

According to various embodiments, N bits N>=1 of the short message may be mapped to positioning methods, respectively. For example, each positioning method (e.g., OTDOA/ECID/Multi-RTT/GNSS/barometric pressure sensor/WLAN/Bluetooth/TBS/motion sensor, etc.) may be assigned one bit and/or mapped to one bit. For example, the value of each bit being “0” (or “1”) may correspond/be mapped to a positioning method corresponding to/mapped each bit being “Off” (and/or “disabled”). The value being ‘1’ (or ‘0’) to correspond/be mapped to may correspond/be mapped to a positioning method corresponding to/mapped each bit being “On” (and/or “enabled”). For example, the BS/server/LMF may indicate a positioning method using “On”/“Off” (and/or “enabled”/“disabled”) of the bit, and the UE may carry out only the indicated positioning method. For example, the value of N may correspond to the number of positioning methods that may be configured/indicated. For example, when the OTDOA/ECID/barometric pressure sensor/WLAN/Bluetooth/TBS/motion sensor is configurable for the UE, N may be set to N=7.

According to various embodiments, the positioning method carried out by the UE may be changed according to On/Off (and/or enabling/disabling) of the positioning method according to each bit. According to various embodiments, a report value for a measurement report of the UE (when the UE reports location information) may vary depending on On/Off (and/or enabling/disabling) of the positioning method according to each bit. For example, when the OTDOA is on/enabled, the UE may report the RSTD and/or report the acquired location information based on the RSTD/OTDOA. For example, when the measurement method based on the barometric pressure sensor is on/enabled, the UE may report the measured value of the barometric pressure sensor and/or report the acquired location information according to the measurement method based on the barometric pressure sensor.

For example, the short message may have reserved bits of 7 bits in addition to system information modification and CMAS/ETWS notification. In this case, for example, the respective bits may be sequentially mapped to OTDOA/ECID/barometric pressure sensor/WLAN/Bluetooth/TBS/motion sensor. That is, in this case, for example, the 7 bits may be a bitmap for configuring/indicating a positioning method among the OTDOA/ECID/barometric pressure sensor/WLAN/Bluetooth/TBS/motion sensor. For example, when the short message is configured in 9 bits and the bit value of the short message in 9 bits excluding the lowest 2 bits (and/or MSB 2 bits) (for system information modification and indication of ETWS and CMAS) is “xx1000000,”, the UE may perform the measurement by the OTDOA. For example, when the bit value of the short message in 9 bits is “xx0100000,” the UE may perform the measurement by the ECID.

According to various embodiments, information required for each measurement method may be transmitted through system information. For example, assistance data for positioning may be transmitted from the system information. For example, the assistance data may include a PRS ID (identifier) for identifying the DL PRS resource. For example, the assistance data may be configured from the server/LMF, and may be transmitted to the UE through the SIB (e.g., positioning system information block (posSIB)) via the BS.

According to various embodiments, the short message may be defined/modified as shown in Table 7 and/or understood as shown in Table 7.

TABLE 7

| Bit | Short Message |
|---|---|
| 1 | systemInfoModification |
| | If set to 1: indication of a BCCH modification |
| | other than SIB6, SIB7 and SIB8. |
| 2 | etwsAndCmasIndication |
| | If set to 1: indication of an ETWS primary notification and/or an |
| | ETWS secondary notification and/or a CMAS notification. |
| 3-8 | Bitmap indicates positioning measurement method. |
| | A bit in the bitmap set to 1 indicates that corresponding positioning |
| | measurement method is enabled/On. |

According to various embodiments, bits 3 to 8 may be a bitmap for configuring/indicating a positioning measurement method. For example, when the bit in the bitmap is set to 1 (or 0), the positioning measurement method corresponding to the bit set to 1 (or 0) may be on/enabled. For example, when the bit in the bitmap is set to 0 (or 1), the positioning measurement method corresponding to the bit set to 0 (or 1) may be off/disabled. In the present example, the size of the bitmap is illustrated as 7, but this is merely an example. According to various embodiments, the size of the bitmap may have a value other than 7.

In Alt.2 according to various embodiments, the short message indicator may be ‘10.’ That is, in Alt.2 according to various embodiments, the value of the bit field for the positioning measurement indication described in Alt.1 may correspond/be mapped to a short message being included in the DCI.

For example, according to various embodiments, Alt.1 and Alt.2 may be carried out separately or in combination. For example, the UE may receive first DCI. For example, a value of the bit field for the positioning measurement indication included in the first DCI may correspond/be mapped to a short message being included. For example, the UE may carry out a measurement method configured/indicated from a bitmap included in the short message. As another example, the UE may identify a measurement method to be carried out by the UE from the bitmap included in the short message. For example, the UE may receive second DCI. For example, a value of a bit field for a positioning measurement indication included in the second DCI may correspond/be mapped to positioning measurement being configured/indicated for the UE. For example, the UE may perform the positioning measurement. For example, the UE may carry out a default measurement method, and/or a measurement method corresponding to a required measured value, and/or a measurement method identified from the first DCI. For example, the first DCI may be received first and/or the second DCI may be received first.

Method 2: Using PDCCH and PDSCH (Paging Message)

In Method 1 according to various embodiments described above, information required for each positioning measurement may be pre-transmitted through system information. For example, the information required for positioning measurements is treated as system information, and accordingly paging may need to be transmitted for change of the information required for positioning measurements every time the information is changed.

In Method 2 according to various embodiments, information related to/required for positioning measurement may be transmitted in a (paging) message such that Method 1 may be supplemented. For example, basically required information in the information related to the positioning measurement may be transmitted from system information, and information that may frequently change according to each measurement method in the information related to the positioning measurement may be transmitted from PDSCH. That is, for example, information that is less likely to be changed in the information related to/required for the positioning measurement may be configured from the system information, and information that is highly likely to be changed may be configured from the PDSCH.

According to various embodiments, the information that is highly likely to be changed may represent an IE that the BS/server/LMF flexibly configures, and/or intends to flexibly configure, and/or is likely to flexibly configure among the IEs included in the assistance data for positioning. The information that is less likely to be changed may represent the other IEs. That is, according to various embodiments, all IEs in the assistance data may be candidate contents that may be information that is relatively highly likely to be changed.

For example, assistance data for OTDOA may include reference cell information for the OTDOA and neighbor cell information:

1) When it is determined that flexible configuration of the reference cell information between the reference cell information and the neighbor cell information is required, the reference cell information may be transmitted from the PDSCH as information that is highly likely to be changed, and the neighbor cell information (and/or other IEs included in the assistance data for the OTDOA) may be transmitted from the system information as information that is less likely to be changed.

2) When it is determined that flexible configuration of the neighbor cell information between the reference cell information and the neighbor cell information is required, the neighbor cell information may be transmitted from the PDSCH as information that is highly likely to be changed, and the reference cell information (and/or other IEs included in the assistance data for the OTDOA) may be transmitted from the system information as information that is less likely to be changed.

3) When it is determined that flexible configuration of both the reference cell information and the neighbor cell information is required, both the reference cell information and the neighbor cell information may be transmitted from the PDSCH as information that is highly likely to be changed, and other IEs included in the assistance data for OTDOA may be transmitted from the system information as information that is less likely to be changed.

As another example, when there is information required to be replaced/changed/updated in the information required for positioning measurement transmitted from the SIB, the replaced/changed/updated information may be transmitted from the PDSCH.

According to various embodiments, at least some information (partial reference information) in the information related to/required for positioning measurement may be transmitted from the PDSCH. As described in Alt. 2 of Method 1 according to various embodiments, information required for each measurement method may be transmitted in the system information. For example, the information transmitted in the system information may be part of the information required for each measurement method, and the remaining information may be transmitted on the PDSCH.

According to various embodiments, Alt.1 of Method 1 according to various embodiments may be basically carried out, and information about provision of location information (e.g., function 2) may be UE-specifically and/or group-specifically transmitted on the PDSCH. For example, when the amount of information is large (e.g., the amount of information is beyond the amount that is transmittable in a paging message) and/or resources on which the paging message is transmitted are limited, a reserved bit field in the DCI may be used to additionally indicate information about the provision of location information (e.g., function 2) in addition to time/frequency resource allocation related to the paging message in a group-common manner.

For example, when the BS/server/LMF desires to configure/indicate positioning measurement for a specific and/or UE group on a specific paging occasion (PO), the bit field of the short message indicator may be ‘11.’ For example, a value of the bit field related to configuring/indicating the positioning measurement may correspond/be mapped to both scheduling information for paging and a short message being included in the DCI. For example, 1 bit for system information modification and 1 bit for ETWS and CMAS indication may be changed according to each PO, and the remaining N bits may be mapped to respective positioning measurement methods, and thus the BS/server/LMF may configure/indicate a measurement for the UE. For example, the UE reading/acquiring the information may receive information required for each positioning method through a paging message, and/or may acquire information required for positioning measurement in a group-specific manner on the PDSCH using time/frequency resource allocation information used in a reserved bit of the PDCCH for paging. For example, the BS may allocate a resource to the PDSCH for transmitting information required for measurement, in consideration of a resource on which the PRS is transmitted. For example, the PRS may be transmitted before or after the PDSCH.

For example, when the BS/server/LMF desires to configure/indicate positioning measurement for a specific and/or UE group on a specific PO, the bit field of the short message indicator may be ‘01’. For example, a value of the bit field related to configuring/indicating the positioning measurement may correspond/be mapped to scheduling information for paging being included in the DCI. For example, the UE reading/acquiring the information may acquire information required for positioning measurement in a group-specific manner on the PDSCH using time/frequency resource allocation information used in a reserved bit of the PDCCH for paging.

According to various embodiments, location information and/or resource information for measurement report of the UE may be included in the PDSCH. For example, when the resource information for the measurement report is included in the PDSCH, the UE may receive/acquire resource information for the measurement report from the PDSCH. For example, the UE may report/transmit a measurement report on a resource identified according to the resource information for the measurement report.

For example, according to various embodiments, Method 1 and Method 2 may be carried out separately or in combination. For example, the UE may receive first DCI. For example, a value of the bit field for the positioning measurement indication included in the first DCI may correspond/be mapped to scheduling information for paging being included and/or both the scheduling information for paging and a short message being included. For example, the UE may acquire at least a portion of information required for positioning measurement from the PDSCH scheduled from the first DCI. For example, the remaining information may be acquired from the SIB. For example, when the short message is included in the DCI, the UE may carry out a measurement method configured/indicated from a bitmap included in the short message. For example, the UE may receive second DCI. For example, a value of a bit field for a positioning measurement indication included in the second DCI may correspond/be mapped to positioning measurement being configured/indicated for the UE. For example, the UE may perform the positioning measurement. For example, the UE may carry out a default measurement method, and/or a measurement method corresponding to a required measured value, and/or a measurement method identified from the first DCI. For example, information required to carry out the measurement method may be acquired from the above-described PDSCH and SIB. For example, the first DCI may be received first and/or the second DCI may be received first.

Method 3: Using PDSCH (Paging Message)

According to various embodiments, only PDSCH may be used to transmit location information.

According to various embodiments, the information is transmitted on the PDSCH. Accordingly, the BS/server/LMF may identify the information with the paging by the scheduling information when configuration the short message indicator. For example, when there is a UE for which positioning measurement is to be indicated, the BS/server/LMF may set the bit field of the short message indicator to ‘01’ and/or ‘11’ depending on whether there is an accompanying short message, and transmit the short message and/or the paging.

That is, according to various embodiments, location information may be transmitted from the PDSCH and identified with the paging by scheduling information. Accordingly, the value of the bit field for positioning measurement may indicate that scheduling information for paging information is included in the DCI included in the bit field. For example, when the bit field for indicating the positioning measurement has a first value, it may correspond/be mapped to the positioning measurement being configured/indicated for the UE. When the bit field for indicating the positioning measurement has a second value, it may correspond/be mapped to scheduling information for paging being included in the DCI. When the bit field for indicating the positioning measurement has a third value, it may correspond/be mapped to a short message being included in the DCI. When the bit field for indicating the positioning measurement has a fourth value, it may correspond/be mapped to the scheduling information and the short message being included in the DCI. Accordingly, in this case, for example, when there is a UE for which the positioning measurement is to be indicated, the BS/server/LMF may set the bit field for indicating the positioning measurement to the second value and/or the fourth value, and transmit the same and/or paging.

According to various embodiments, the positioning measurement (e.g., UE-based positioning measurement) may be UE-specifically configured/indicated for each UE.

According to various embodiments, an additional mechanism for presenting corresponding information may be provided such that it may be distinguished whether the paging is transmitted for scheduling information (e.g., UE record) or (additionally) for positioning measurement. For example, when the short message indicator is ‘01’ or ‘11,’ the UE may attempt to decode the paging message. For example, the UE may attempt/initiate a random access procedure (and/or attempt/initiate an RRC connection resumption procedure) and/or perform PRS measurement based on a factor/information for distinguishing the purpose of paging in the paging message.

Hereinafter, a method of transmitting location information in a UE-specific or group-specific manner according to various embodiments, and a factor/information configuration for distinguishing between the purpose of RRC connection triggering and the purpose of positioning measurement will be described.

Alt.1: UE-Specific Configuration

According to various embodiments, location information may be transmitted from the BS/server/LMF through a paging message for each UE. According to various embodiments, the location information may be transmitted in order of paging records in a paging record list (e.g., PagingRecordList). According to various embodiments, the paging records may further carry/include information (e.g., 1 bit) for indicating/distinguishing the purpose of paging in addition to identity information about the UE such as temporary mobile subscriber identity (TMSI)/inactive RNTI (I-RNTI). For example, the information for indicating/distinguishing the purpose of paging may be information indicating/distinguishing whether the purpose of paging is RRC connection triggering or positioning measurement.

For example, when the 1 bit for distinguishing between the purpose of RRC connection triggering and the purpose of positioning measurement present in each paging record is ‘0’ (or ‘1’), the UE may perform/initiate the random access procedure (and/or perform/initiate the RRC connection resumption procedure) after checking whether the ID of the paging matches the ID of the UE. In contrast, for example, when the 1 bit is ‘1’ (or ‘0’), the UE may perform positioning measurement.

For example, when the size of the location information is large (for example, when the size of the location information is beyond the transmittable size in the paging record), information about the time/frequency resource allocation for transmitting the corresponding information may be transmitted for each UE through the paging record, and the UE may acquire the location information on the corresponding resource. For example, the paging record may include time/frequency resource allocation information for transmitting the location information. For example, the UE may receive/acquire the location information on a resource identified by the time/frequency resource allocation information based on the time/frequency resource allocation information included in the paging record. According to various embodiments, the resource identified by the time/frequency resource allocation information may include location information and/or resource information for a measurement report of the UE. For example, when the resource identified by the time/frequency resource allocation information includes the resource information for the measurement report, the UE may receive/acquire the resource information for the measurement report on the resource identified by the time/frequency resource allocation information. For example, the UE may report/transmit the measurement report on the resource identified according to the resource information for the measurement report.

According to various embodiments, as described above in Alt.2 of Method 1, bitmap information mapped to each positioning method in a one-to-one correspondence manner may be (additionally) carried in the paging record such that each positioning method may be configured/indicated for the UE. For example, in this case, the information for distinguishing between the purpose of RRC connection triggering and the purpose of positioning measurement described above may not be included. For example, N bits (N>=1) (for the positioning method) may be included/carried in addition to the UE-identity and the access type in the paging record. For example, when all the N bits are ‘0’ (or ‘1’), the UE may determine that the purpose of paging is RRC connection triggering. For example, when the N bits have one or more ‘1’s (or one or more ‘0’s), the UE may perform measurement using a positioning method corresponding to ‘1’ (or ‘0’), and calculate/acquire a result value thereof. According to various embodiments, the bitmap information may be carried in the paging record as described above, and thus the size/information amount of the location information (e.g., providelocationinformation) transmitted based on LPP/RRC/SIB may be reduced.

Alt.2: Group-Specific Configuration

For example, when the UE-specific transmission is performed, the signaling overhead may increase as the number of UEs (and/or records/paging records) included in the paging record list increases. According to various embodiments, in order to prevent the increase, location information may be transmitted as common information about a group including one or more UEs. For example, the location information may be directly transmitted in the paging message as common information about all UEs included in the paging record list, and/or time/frequency resource allocation information in which the information is transmitted may be carried.

According to various embodiments, information (e.g., 1 bit) for indicating the purpose of paging (scheduling) may be carried/included in the paging message such that the purpose of the paging (scheduling) may be distinguished. According to various embodiments, the information for indicating/distinguishing the purpose of paging may be group-common information. For example, when the 1 bit for indicating/distinguishing the purpose of the paging present in the paging message is ‘0’ (or ‘1’), the UE may perform/initiate the random access procedure (and/or perform/initiate the RRC connection resumption procedure) after checking whether the ID of the paging matches the ID of the UE. In contrast, for example, when the 1 bit is ‘1’ (or ‘0’), the UE may perform positioning measurement. For more details, the details described regarding the UE-specific configuration in Alt.1 according to various embodiments may be applied.

In the above description, various embodiments have been described about an example case where the size of the information for indicating/distinguishing the purpose of paging is 1 bit and the size of the bit field for indicating positioning measurement is 2 bits. However, various embodiments are not limited thereto. According to various embodiments, the size of the information for indicating/distinguishing the purpose of paging may have various values as well as 1 bit.

For example, the size of the information for indicating/distinguishing the purpose of paging may be greater than 1 bit. In this case, when the information for indicating/distinguishing the purpose of paging has a first value, it may correspond/be mapped to an indication that the UE should perform/initiate/attempt the random access procedure (and/or perform/initiate the RRC connection resumption procedure). For example, when the information for indicating/distinguishing the purpose of paging has a second value, it may correspond/be mapped to an indication that the UE should perform positioning measurement. For example, when the information for indicating/distinguishing the purpose of paging has a value other than the first and second values, it may correspond/be mapped to reserved and/or be used to transmit another indication/configuration to the UE.

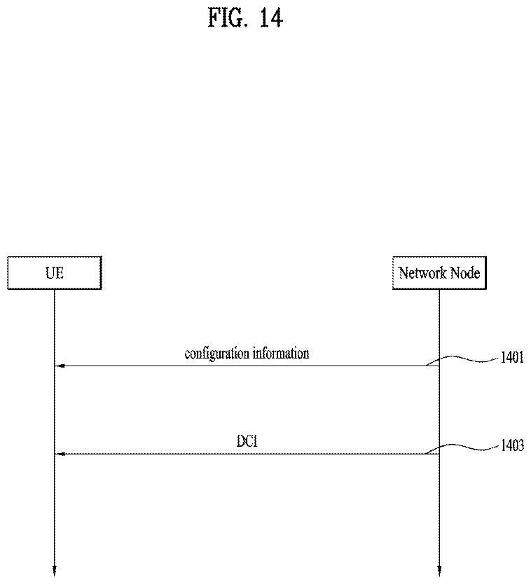

FIG. 14 is a diagram schematically illustrating a method of operating a UE and network nodes according to various embodiments.

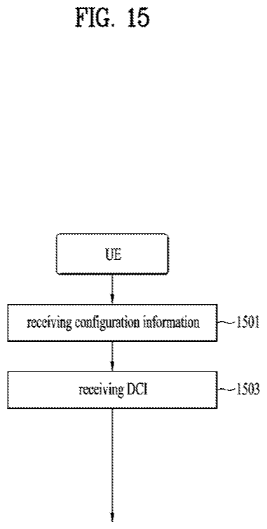

FIG. 15 is a flowchart illustrating a method of operating a UE according to various embodiments.

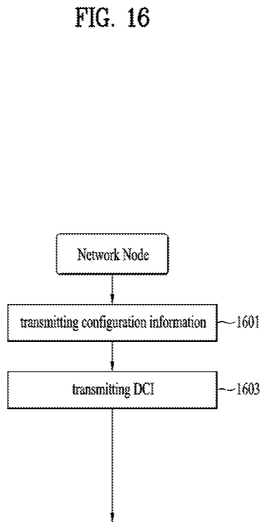

FIG. 16 is a flowchart illustrating a method of operating a network node according to various embodiments. For example, a network node may be a TP, and/or, a BS, and/or, a cell, and/or a location server, and/or an LMF, and/or any device that performs the same operation.

Referring to FIGS. 14 to 16, in operations 1401, 1501, and 1601 according to various embodiments, the network node may transmit/broadcast configuration information related to paging, and the UE may receive the same.

In operations 1403, 1503, and 1603 according to various embodiments, the network node may transmit downlink control information (DCI) having a cyclic redundancy check (CRC) scrambled with a radio network temperature identifier (RNTI) related to the paging, and the UE may receive the same.

According to various embodiments, the DCI may include a first bit field.

According to various embodiments, the first bit field having a first value may be mapped to the UE being configured to acquire a measurement related to positioning.

According to various embodiments, the first bit field having a second value may be mapped to scheduling information for the paging being included in the DCI.

Specific operations of the UE and/or the network node according to the above-described various embodiments may be described and performed based on Section 1 to Section 3 described before.

Since examples of the above-described proposal method may also be included in one of implementation methods of the various embodiments, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

### 4. Exemplary Configurations of Devices Implementing Various Embodiments

4.1. Exemplary Configurations of Devices to which Various Embodiments are Applied

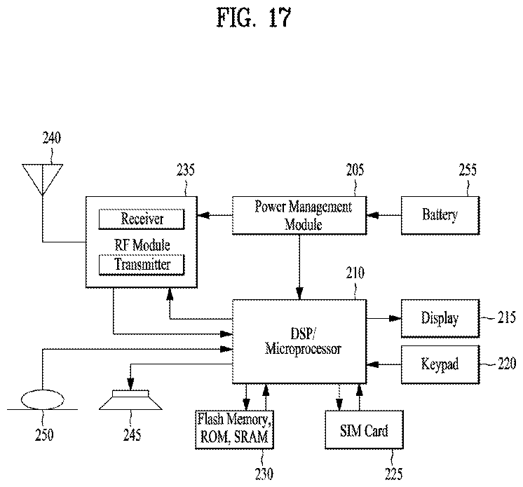

FIG. 17 is a diagram illustrating a device that implements various embodiments.

The device illustrated in FIG. 17 may be a UE and/or a BS (e.g., eNB or gNB or TP) and/or a location server (or LMF) which is adapted to perform the above-described mechanism, or any device performing the same operation.

Referring to FIG. 17, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 17 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 17 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor of a UE (or a communication device included in the UE) and/or a BS (or a communication device included in the BS) and/or a location server (or a communication device included in the location server) may operate by controlling a memory, as follows.

According to various embodiments, the UE or the BS or the location server may include at least one transceiver, at least one memory, and at least one processor coupled to the at least one transceiver and the at least one memory. The at least one memory may store instructions which cause the at least one processor to perform the following operations.

The communication device included in the UE or the BS or the location server may be configured to include the at least one processor and the at least one memory. The communication device may be configured to include the at least one transceiver or to be coupled to the at least one transceiver without including the at least one transceiver.

The TP and/or the BS and/or the cell and/or the location server and/or the LMF and/or any device performing the same operation may be referred to as a network node.

According to various embodiments, one or more processors included in the UE (or one or more processors of the communication device included in the UE) may receive configuration information related to paging.

According to various embodiments, the one or more processors included in the UE may receive, based on the configuration information, downlink control information (DCI) having a cyclic redundancy check (CRC) scrambled with a radio network temporary identifier (RNTI) related to the paging.

According to various embodiments, the DCI may include a first bit field.

According to various embodiments, the first bit field having a first value may be mapped to the UE being configured to acquire a measurement related to positioning.

According to various embodiments, the first bit field having a second value may be mapped to scheduling information for the paging being included in the DCI.

According to various embodiments, one or more processors included in the network node (or one or more processors of the communication device included in the network node) may transmit/broadcast configuration information related to the paging.

According to various embodiments, the one or more processors included in the network node may transmit downlink control information (DCI) having a cyclic redundancy check (CRC) scrambled with a radio network temperature identifier (RNTI) related to the paging.

According to various embodiments, the DCI may include a first bit field.

According to various embodiments, the first bit field having a first value may be mapped to the UE being configured to acquire a measurement related to positioning.

According to various embodiments, the first bit field having a second value may be mapped to scheduling information for the paging being included in the DCI.

Specific operations of the UE and/or the network node according to the above-described various embodiments may be described and performed based on Section 1 to Section 3 described before.

Unless contradicting each other, various embodiments may be implemented in combination. For example, (the processor included in) the UE and/or the network node according to various embodiments may perform operations in combination of the embodiments of the afore-described in Section 1 to Section 3, unless contradicting each other.

4.2. Example of Communication System to which Various Embodiments are Applied

Various embodiments have been mainly described in relation to data transmission and reception between a BS and a UE in a wireless communication system. However, various embodiments are not limited thereto. For example, various embodiments may also relate to the following technical configurations.

The various descriptions, functions, procedures, proposals, methods, and/or operational flowcharts of the various embodiments described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

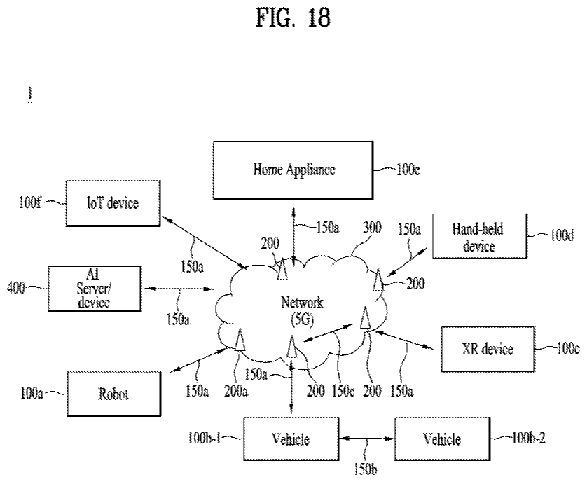

FIG. 18 illustrates an exemplary communication system to which various embodiments are applied.

Referring to FIG. 18, a communication system 1 applied to the various embodiments includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the various embodiments.

Example of Wireless Devices to which Various Embodiments are Applied

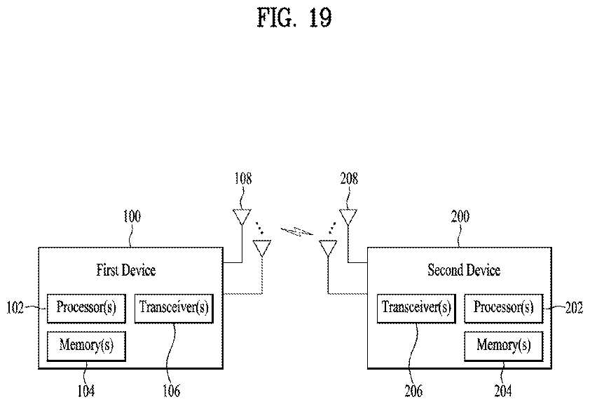

FIG. 19 illustrates exemplary wireless devices to which various embodiments are applicable.

Referring to FIG. 19, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 18.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the various embodiments, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the various embodiments, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to various embodiments, one or more memories (e.g., 104 or 204) may store instructions or programs which, when executed, cause one or more processors operably coupled to the one or more memories to perform operations according to various embodiments or implementations of the present disclosure.

According to various embodiments, a computer-readable storage medium may store one or more instructions or computer programs which, when executed by one or more processors, cause the one or more processors to perform operations according to various embodiments or implementations of the present disclosure.

According to various embodiments, a processing device or apparatus may include one or more processors and one or more computer memories connected to the one or more processors. The one or more computer memories may store instructions or programs which, when executed, cause the one or more processors operably coupled to the one or more memories to perform operations according to various embodiments or implementations of the present disclosure.

Example of Using Wireless Devices to which Various Embodiments are Applied

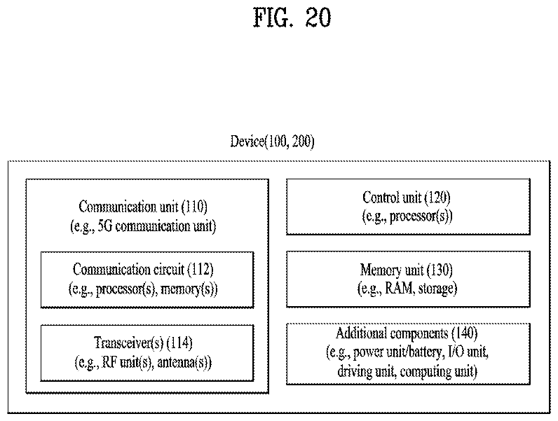

FIG. 20 illustrates other exemplary wireless devices to which various embodiments are applied. The wireless devices may be implemented in various forms according to a use case/service (see FIG. 18).

Referring to FIG. 20, wireless devices 100 and 200 may correspond to the wireless devices 100 and 200 of FIG. 19 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 19. For example, the transceiver(s) 114 may include the one or more transceivers 106 and 206 and/or the one or more antennas 108 and 208 of FIG. 19. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 18), the vehicles (100b-1 and 100b-2 of FIG. 18), the XR device (100c of FIG. 18), the hand-held device (100d of FIG. 18), the home appliance (100e of FIG. 18), the IoT device (100f of FIG. 18), a digital broadcast terminal, a hologram device, a public safety device, an MTC device, a medicine device, a fintech device (or a finance device), a security device, a climate/environment device, the AI server/device (400 of FIG. 18), the BSs (200 of FIG. 18), a network node, etc. The wireless device may be used in a mobile or fixed place according to a use-example/service.

In FIG. 20, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 20 will be described in detail with reference to the drawings.

Example of Portable Device to which Various Embodiments are Applied

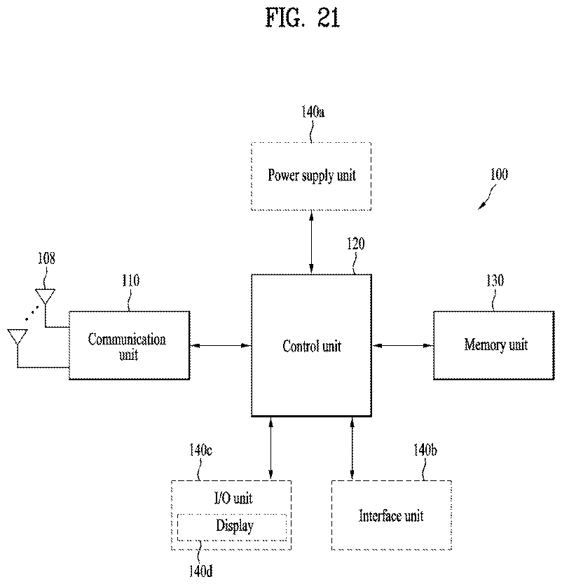

FIG. 21 illustrates an exemplary portable device to which various embodiments are applied. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 21, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 20, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Example of Vehicle or Autonomous Driving Vehicle to which Various Embodiments.

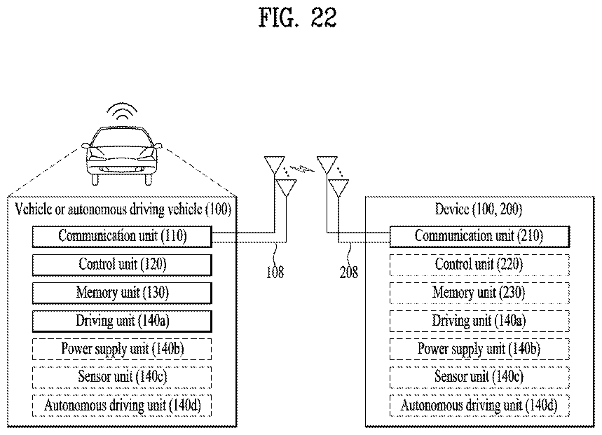

FIG. 22 illustrates an exemplary vehicle or autonomous driving vehicle to which various embodiments. The vehicle or autonomous driving vehicle may be implemented as a mobile robot, a car, a train, a manned/unmanned aerial vehicle (AV), a ship, or the like.

Referring to FIG. 22, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 20, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

In summary, various embodiments may be implemented through a certain device and/or UE.

For example, the certain device may be any of a BS, a network node, a transmitting UE, a receiving UE, a wireless device, a wireless communication device, a vehicle, a vehicle equipped with an autonomous driving function, an unmanned aerial vehicle (UAV), an artificial intelligence (AI) module, a robot, an augmented reality (AR) device, a virtual reality (VR) device, and other devices.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi mode-multi band (MM-MB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

The wireless communication technology in which various embodiments are implemented may include LTE, NR, and 6G, as well as narrowband Internet of things (NB-IoT) for low power communication. For example, the NB-IoT technology may be an example of low power wide area network (LPWAN) technology and implemented as the standards of LTE category (CAT) NB1 and/or LTE Cat NB2. However, these specific appellations should not be construed as limiting NB-IoT. Additionally or alternatively, the wireless communication technology implemented in a wireless device according to various embodiments may enable communication based on LTE-M. For example, LTE-M may be an example of the LPWAN technology, called various names such as enhanced machine type communication (eMTC). For example, the LTE-M technology may be implemented as, but not limited to, at least one of 1) LTE CAT 0, 2) LTE Cat M1, 3) LTE Cat M2, 4) LTE non-bandwidth limited (non-BL), 5) LTE-MTC, 6) LTE machine type communication, and/or 7) LTE M. Additionally or alternatively, the wireless communication technology implemented in a wireless device according to various embodiments may include, but not limited to, at least one of ZigBee, Bluetooth, or LPWAN in consideration of low power communication. For example, ZigBee may create personal area networks (PANs) related to small/low-power digital communication in conformance to various standards such as IEEE 802.15.4, and may be referred to as various names.

Various embodiments may be implemented in various means. For example, various embodiments may be implemented in hardware, firmware, software, or a combination thereof.

In a hardware configuration, the methods according to exemplary embodiments may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the various embodiments may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the various embodiments may be carried out in other specific ways than those set forth herein without departing from the spirit and essential characteristics of the various embodiments. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment or included as a new claim by a subsequent amendment after the application is filed.

### INDUSTRIAL APPLICABILITY

The various embodiments are applicable to various wireless access systems including a 3GPP system, and/or a 3GPP2 system. Besides these wireless access systems, the various embodiments are applicable to all technical fields in which the wireless access systems find their applications. Moreover, the proposed method can also be applied to mmWave communication using an ultra-high frequency band.

1. A method performed by an apparatus in a wireless communication system, the method comprising:
receiving configuration information related to paging; and
receiving, based on the configuration information, downlink control information (DCI) having a cyclic redundancy check (CRC) scrambled with a radio network temporary identifier (RNTI) related to the paging,
wherein the DCI includes a first bit field,
wherein:
the first bit field having a first value is mapped to the apparatus being configured to acquire a measurement related to positioning; and
the first bit field having a second value is mapped to scheduling information for the paging being included in the DCI.

2. The method of claim 1, wherein:
the first bit field having a third value is mapped to a short message being included in the DCI; and
the first bit field having a fourth value is mapped to the scheduling information and the short message being included in the DCI,
wherein the short message includes:
(i) information about system information modification; and
(ii) an indication related to one or more of an earthquake and tsunami warning system (ETWS) or a commercial mobile alert system (CMAS).

3. The method of claim 2, wherein the short message further includes a second bit field,
wherein a most significant bit (MSB) of the second bit field includes information about the system information modification,
wherein a second MSB of the second bit field includes information about an indication related to one or more of the ETWS or the CMAS,
wherein remaining bits of the second bit field except for the MSB and the second MSB include a bitmap for configuring a positioning method for acquiring the measurement.

4. The method of claim 1, wherein, based on the first bit field having the first value:
(i) the measurement is acquired; and
(ii) a paging message related to the paging is not expected to be received.

5. The method of claim 1, wherein the terminal is included in a group including one or more terminals,
wherein the first bit field having the first value is mapped to the one or more terminals included in the group being configured to acquire the measurement in a group-common manner.

6. The method of claim 1, wherein, based on the first bit field having the first value, a positioning reference signal (PRS) used to acquire the measurement is received after a reception time of the DCI.

7. A terminal operating in a wireless communication system, comprising:
a transceiver; and
one or more processors connected to the transceiver,
wherein the one or more processors are configured to:
receive configuration information related to paging; and
receive, based on the configuration information, downlink control information (DCI) having a cyclic redundancy check (CRC) scrambled with a radio network temporary identifier (RNTI) related to the paging,
wherein the DCI includes a first bit field,
wherein:
the first bit field having a first value is mapped to the terminal being configured to acquire a measurement related to positioning; and
the first bit field having a second value is mapped to scheduling information for the paging being included in the DCI.

8. The terminal of claim 7, wherein:
the first bit field having a third value is mapped to a short message being included in the DCI; and
the first bit field having a fourth value is mapped to the scheduling information and the short message being included in the DCI,
wherein the short message includes:
(i) information about system information modification; and
(ii) an indication related to one or more of an earthquake and tsunami warning system (ETWS) or a commercial mobile alert system (CMAS).

9. The terminal of claim 8, wherein the short message further includes a second bit field,
wherein a most significant bit (MSB) of the second bit field includes information about the system information modification,
wherein a second MSB of the second bit field includes information about an indication related to one or more of the ETWS or the CMAS,
wherein remaining bits of the second bit field except for the MSB and the second MSB include a bitmap for configuring a positioning method for acquiring the measurement.

10. The terminal of claim 7, wherein the terminal is included in a group including one or more terminals,
wherein the first bit field having the first value is mapped to the one or more terminals included in the group being configured to acquire the measurement in a group-common manner.

11. The terminal of claim 7, wherein the one or more processors are configured to communicate with one or more of a mobile terminal, a network, and an autonomous vehicle other than a vehicle containing the apparatus.

12. A method carried out by an apparatus in a wireless communication system, the method comprising:
transmitting configuration information related to paging; and
transmitting downlink control information (DCI) having a cyclic redundancy check (CRC) scrambled with a radio network temporary identifier (RNTI) related to the paging,
wherein the DCI transmitted to a terminal includes a first bit field,
wherein:
the first bit field having a first value is mapped to the terminal being configured to acquire a measurement related to positioning; and
the first bit field having a second value is mapped to scheduling information for the paging being included in the DCI.

13. A base station operating in a wireless communication system, comprising:
a transceiver; and
one or more processors connected to the transceiver,
wherein the one or more processors are configured to:
transmit configuration information related to paging; and
transmit downlink control information (DCI) having a cyclic redundancy check (CRC) scrambled with a radio network temporary identifier (RNTI) related to the paging,
wherein the DCI transmitted to a terminal includes a first bit field,
wherein:
the first bit field having a first value is mapped to the terminal being configured to acquire a measurement related to positioning; and
the first bit field having a second value is mapped to scheduling information for the paging being included in the DCI.

14-15. (canceled)
